(19) United States
(12) Patent Application Publication
(10) Pub. No.: US 2013/0023403 A1
(43) Pub. Date: Jan. 24, 2013

(54) METAL ORGANIC MATERIALS AS BIOMIMETIC ENZYMES

(71) Applicants: Randy W. Larsen, Tampa, FL (US); Carissa M. Vetromile, Honolulu, HI (US); Jason A. Perman, Tampa, FL (US); Lukasz Wojtas, Tampa, FL (US); Michael J. Zaworotko, Tampa, FL (US); Mohamed Eddaoudi, Tampa, FL (US); Yunling Liu, Changchun (CN)

(72) Inventors: Randy W. Larsen, Tampa, FL (US); Carissa M. Vetromile, Honolulu, HI (US); Jason A. Perman, Tampa, FL (US); Lukasz Wojtas, Tampa, FL (US); Michael J. Zaworotko, Tampa, FL (US); Mohamed Eddaoudi, Tampa, FL (US); Yunling Liu, Changchun (CN)

(73) Assignee: University of South Florida, Tampa, FL (US)

(21) Appl. No.: 13/412,308

(22) Filed: Mar. 5, 2012

Related U.S. Application Data
(60) Provisional application No. 61/448,974, filed on Mar. 3, 2011.

(51) Int. Cl. B01J 31/22

(52) U.S. Cl. 502/164; 502/171; 502/167; 502/170; 502/168; 502/162

(57) ABSTRACT

A supramolecular assembly comprising a metal-organic molecular framework and a heterocyclic macrocycle guest molecule. The metal-organic molecular framework comprises cubicuboctahedral cavities, octahemioctahedral cavities and trigonal cavities in a 1:1:2 ratio, respectively, and the heterocyclic macrocycle guest molecule is hosted by the octahemioctahedral cavity. In a preferred embodiment, the heterocyclic macrocycle guest molecule is a heme.

### CROSS-REFERENCE TO RELATED APPLICATIONS

This application claims priority to U.S. Provisional Application Ser. No. 61/448,974, filed Mar. 3, 2011, which is incorporated herein by reference in its entirety.

### FIELD OF THE INVENTION

The present invention generally relates to metal-organic materials with selectively encapsulated guest molecules, their modes of synthesis, and methods of use.

### BACKGROUND OF THE INVENTION

Heme proteins represent one of the most diverse classes of metallo-enzymes in nature and are ubiquitous to all organisms.¹⁻⁴ This class of protein participates in diverse catalytic chemistry ranging from relatively simple electron transfer to complex monooxygen reactions. This broad catalytic diversity is achieved using a single type of heme macrocycle (iron protoporphyrin IX) selectively encapsulated within a protein cavity which allows ligand access to the fifth and sixth coordination sites of the central iron. The protein structure also provides functionally distinct distal and proximal pockets as well as specific pathways leading from solution to the heme active site that allows for size selectivity of the substrate.^{5,6} Metal-organic materials (MOMs) that are based upon multiple polyhedral cages⁷⁻¹¹ offer excellent platforms for the development of MOM-based heme biomimetic catalytic systems since these polyhedral MOMs share two common structural features with heme proteins; large pockets (cages) which can accommodate a catalytic metalloporphyrin; access channels which connect the bulk solvent to various other cages within the porous material.

### SUMMARY OF THE INVENTION

Among the various aspects of the present invention is the provision of metal-organic materials (MOMs) as hosts for heterocyclic macrocycle guest molecules. MOMs offer un-paralleled levels of permanent porosity and their modular nature affords enormous diversity of structures and properties, thus defining a new paradigm for catalysis or any of the plethora of chemical reactions that may be enzymatically or catalytically carried out in solution. For example, when the guest molecule is a metalloporphyrin, the combination may possess the activity of a homogeneous catalyst with the stability and recyclability of heterogeneous catalytic systems within a single material.

Briefly, therefore, the present invention is directed to a supramolecular assembly comprising a metal-organic molecular framework and a heterocyclic macrocycle guest molecule. The metal-organic molecular framework comprises cubicuboctahedral cavities, octahemioctahedral cavities and trigonal cavities in a 1:1:2 ratio, respectively, and the heterocyclic macrocycle guest molecule is hosted by the octahemioctahedral cavity.

Other objects and features will be in part apparent and in part pointed out hereinafter.

### ABBREVIATIONS AND DEFINITIONS

The following definitions and methods are provided to better define the present invention and to guide those of ordinary skill in the art in the practice of the present invention. Unless otherwise noted, terms are to be understood according to conventional usage by those of ordinary skill in the relevant art.

The following definitions and methods are provided to better define the present invention and to guide those of ordinary skill in the art in the practice of the present invention. Unless otherwise noted, terms are to be understood according to conventional usage by those of ordinary skill in the relevant art.

The terms “acetal” and “ketal,” as used herein alone or as part of another group, denote the moieties represented by the following formulae,

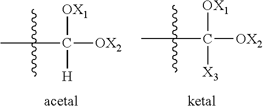

wherein X₁ and X₂ are independently hydrocarbyl, substituted hydrocarbyl, heterocyclo, or heteroaryl, and X₃ is hydrocarbyl or substituted hydrocarbyl, as defined in connection with such terms, and the wavy lines represent the attachment point of the acetal or ketal moiety to another moiety or compound.

The term “acyl,” as used herein alone or as part of another group, denotes the moiety formed by removal of the hydroxy group from the group —COOH of an organic carboxylic acid, e.g., X₄C(O)—, wherein X₄ is X¹, X¹O—, X¹X²N—, or X¹S—, X¹ is hydrocarbyl, heterosubstituted hydrocarbyl, or heterocyclo, and R² is hydrogen, hydrocarbyl or substituted hydrocarbyl. Exemplary acyl moieties include acetyl, propionyl, benzoyl, pyridinylcarbonyl, and the like.

The term “acyloxy,” as used herein alone or as part of another group, denotes an acyl group as described above bonded through an oxygen linkage (—O—), e.g., X₄C(O)O— wherein X₄ is as defined in connection with the term “acyl.”

The term “alkoxy,” as used herein alone or as part of another group, denotes an —OX₅ radical, wherein X₅ is hydrocarbyl or substituted hydrocarbyl.

Unless otherwise indicated, the alkyl groups described herein are preferably lower alkyl containing from one to eight carbon atoms in the principal chain and up to 20 carbon atoms. They may be straight or branched chain or cyclic and include methyl, ethyl, propyl, isopropyl, butyl, hexyl and the like.

The term “alkylene,” as used herein alone or as part of another group, denotes a linear saturated divalent hydrocarbon radical of one to eight carbon atoms or a branched saturated divalent hydrocarbon radical of three to six carbon atoms unless otherwise stated. Exemplary alkylene moieties include methylene, ethylene, propylene, 1-methylpropylene, 2-methylpropylene, butylene, pentylene, and the like.

Unless otherwise indicated, the alkenyl groups described herein are preferably lower alkenyl containing from two to eight carbon atoms in the principal chain and up to 20 carbon atoms. They may be straight or branched chain or cyclic and include ethenyl, propenyl, isopropenyl, butenyl, isobutenyl, hexenyl, and the like.

Unless otherwise indicated, the alkynyl groups described herein are preferably lower alkynyl containing from two to eight carbon atoms in the principal chain and up to 20 carbon atoms. They may be straight or branched chain and include ethynyl, propynyl, butynyl, isobutynyl, hexynyl, and the like.

The terms “amine” or “amino,” as used herein alone or as part of another group, represents a group of formula —N(X₈)(X₉), wherein X₈ and X₉ are independently hydrogen, hydrocarbyl, substituted hydrocarbyl, heteroaryl, or heterocyclo, or X₈ and X₉ taken together form a substituted or unsubstituted alicyclic, aryl, or heterocyclic moiety, each as defined in connection with such term, typically having from 3 to 8 atoms in the ring. “Substituted amine,” for example, refers to a group of formula —N(X₈)(X₉), wherein at least one of X₈ and X₉ are other than hydrogen. “Unubstituted amine,” for example, refers to a group of formula —N(X₈)(X₉), wherein X₈ and X₉ are both hydrogen.

The terms “amido” or “amide,” as used herein alone or as part of another group, represents a group of formula —CON(X₈)(X₉), wherein X₈ and X₉ are as defined in connection with the terms “amine” or “amino.” “Substituted amide,” for example, refers to a group of formula —CON(X₈)(X₉), wherein at least one of X₈ and X₉ are other than hydrogen. “Unsubstituted amido,” for example, refers to a group of formula —CON(X₈)(X₉), wherein X₈ and X₉ are both hydrogen

The terms “aryl” or “Ar” as used herein alone or as part of another group denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl.

The term “arylene”, as used herein alone or part of another group refers to a divalent aryl radical of one to twelve carbon atoms. Non-limiting examples of “arylene” include phenylene, pyridinylene, pyrimidinylene and thiophenylene.

The terms “alkaryl” or “alkylaryl,” as used herein alone or as part of another group, denotes an -(arylene)-X₁₁ radical, wherein X₁₁ is as defined in connection with the term “alkyl.”

The term “chlorin” refers to a compound comprising a fundamental skeleton of three pyrrole nuclei and one pyrroline united through the α-positions by methane groups to form the following macrocyclic structure:

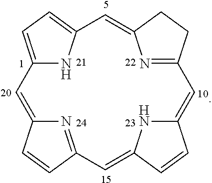

The term “corrin” refers to a compound comprising a fundamental skeleton of three pyrrole nuclei and one pyrroline united through the α-positions by methane groups to form the following macrocyclic structure:

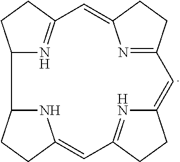

The term “cyano,” as used herein alone or as part of another group, denotes a group of formula —CN.

The term “carbocyclic” as used herein alone or as part of another group refers to a saturated or unsaturated monocyclic or bicyclic ring in which all atoms of all rings are carbon. Thus, the term includes cycloalkyl and aryl rings. The carbocyclic ring(s) may be substituted or unsubstituted. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, ketals, acetals, esters and ethers.

The term “cycloalkyl,” as used herein alone or as part of another group, denotes a cyclic saturated monovalent bridged or non-bridged hydrocarbon radical of three to ten carbon atoms. Exemplary cycloalkyl moieties include cyclopropyl, cyclobutyl, cyclopentyl, cyclohexyl, or adamantyl. Additionally, one or two ring carbon atoms may optionally be replaced with a —CO— group.

The term “ester,” as used herein alone or as part of another group, denotes a group of formula —COOX₁₂ wherein X₁₂ is alkyl or aryl, each as defined in connection with such term.

The term “ether,” as used herein alone or as part of another group, includes compounds or moieties which contain an oxygen atom bonded to two carbon atoms. For example, ether includes “alkoxyalkyl” which refers to an alkyl, alkenyl, or alkynyl group substituted with an alkoxy group.

The terms “halide,” “halogen” or “halo” as used herein alone or as part of another group refer to chlorine, bromine, fluorine, and iodine.

The term “heteroatom” shall mean atoms other than carbon and hydrogen.

The term “heteroaromatic” or “heteroaryl” as used herein alone or as part of another group denote optionally substituted aromatic groups having at least one heteroatom in at least one ring, and preferably 5 or 6 atoms in each ring. The heteroaromatic group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heteroaromatics include furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto (i.e., ═O), hydroxy, protected hydroxy, acyl, acyloxy, alkoxy, alkenoxy, alkynoxy, aryloxy, halogen, amido, amino, nitro, cyano, thiol, ketals, acetals, esters and ethers.

The term “heteroarylene” as used herein alone or as part of another group refers to a divalent heteroaryl radical. Non-limiting examples of “heteroarylene” include furylene, thienylene, pyridylene, oxazolylene, pyrrolylene, indolylene, quinolinylene, or isoquinolinylene and the like.

The terms “heterocyclo” or “heterocyclic” as used herein alone or as part of another group denote optionally substituted, fully saturated or unsaturated, monocyclic or bicyclic, aromatic or nonaromatic groups having at least one heteroatom in at least one ring, and preferably 5 or 6 atoms in each ring. The heterocyclo group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heterocyclo include heteroaromatics such as furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, ketals, acetals, esters and ethers.

The terms “hydrocarbon” and “hydrocarbyl” as used herein describe organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 20 carbon atoms.

The term “hydroxy,” as used herein alone or as part of another group, denotes a group of formula —OH.

The term “keto,” as used herein alone or as part of another group, denotes a double bonded oxygen moiety (i.e., ═O).

The term “meso” refers to the position on the porphyrin, porphyrazin, chlorin, corrin and porphyrinogen structure adjacent to the reduced pyrrole ring, i.e., positions 5, 10, 15, and 20 of the porphyrin macrocycle (and the corresponding carbon or nitrogen atoms in the porphyrazin, chlorin, corrin and porphyrinogen macrocyclic structures). Stated differently, a “meso-porphyrin” is a porphyrin compound comprising substituent groups at the 5, 10, 15, and 20 position, or combinations thereof, a “meso-porphyrazin” is a porphyrazin compound comprising substituent groups at the nitrogen atoms adjacent the pyrrole rings, a “meso-chlorin” is a chlorin compound comprising substituent groups at the carbon atoms adjacent the pyrrole rings, a “meso-corrin” is a corrin compound comprising substituent groups at the carbon atoms adjacent the pyrrole rings, and “meso-pyrophyrinogen” is a pyrophyrinogen compound comprising substituent groups at the carbon atoms adjacent the pyrrole rings.

The term “metalated heterocyclic macrocycle” as used herein denotes a heterocyclic macrocycle containing a coordinated metal, the metal being coordinated, for example, by two or more of the nitrogen atoms at the 21, 22, 23, or 24 position of a porphyrin (a metalated porphyrin) or the corresponding nitrogen atoms of a porphyrazin (a metalated porphyrazin), a chlorin (a metalated chlorin), a corrin (a metalated corrin) and a porphyrinogen (a metalated porphyrinogen).

The term “metalloporphyrin” as used herein is used interchangeably with metalated porphyrin.

The term “nitro,” as used herein alone or as part of another group, denotes a group of formula —NO₂.

The term “porphyrazin” refers to a compound comprising a fundamental skeleton of four pyrrole nuclei united through the α-positions by four amine groups to form the following macrocyclic structure:

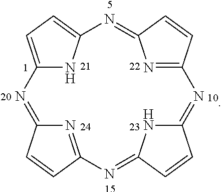

The term “porphyrin” refers to a compound comprising a fundamental skeleton of four pyrrole nuclei united through the α-positions by four methane groups to form the following macrocyclic structure:

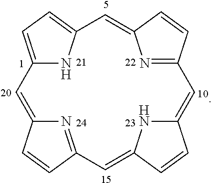

The term “porphyrinogen” refers to a compound comprising a fundamental skeleton of four pyrrole nuclei united through the α-positions by four methane groups to form the following macrocyclic structure:

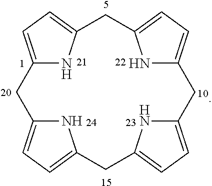

The “substituted hydrocarbyl” moieties described herein are hydrocarbyl moieties which are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, keto, acyl, acyloxy, nitro, amino, amido, nitro, cyano, thiol, ketals, acetals, esters, ethers, and thioethers.

The term “thioether,” as used herein alone or as part of another group, denotes compounds and moieties that contain a sulfur atom bonded to two different carbon or hetero atoms (i.e., —S—), and also includes compounds and moieties containing two sulfur atoms bonded to each other, each of which is also bonded to a carbon or hetero atom (i.e., dithioethers (—S—S—)). Examples of thioethers include, but are not limited to, alkylthioalkyls, alkylthioalkenyls, and alkylthioalkynyls. The term “alkylthioalkyls” includes compounds with an alkyl, alkenyl, or alkynyl group bonded to a sulfur atom that is bonded to an alkyl group. Similarly, the term “alkylthioalkenyls” and alkylthioalkynyls” refer to compounds or moieties where an alkyl, alkenyl, or alkynyl group is bonded to a sulfur atom that is covalently bonded to an alkynyl group.

The term “thiol,” as used herein alone or as part of another group, denotes a group of formula —SH.

### BRIEF DESCRIPTION OF THE DRAWINGS

FIG. 1 (top) is an Illustration of the similarities in overall structural paradigm between heme proteins (left) and the porphyrin encapsulated HKUST-1 MOMzyme-1, right. The diagram of HKUST-1 highlights the three distinct polyhedral cages that make up its structures. FIG. 1 (bottom) is a diagram showing two equivalent orientations of the Mn(III)₄SP within the octahemioctahedral cage of HKUST-1(Cu, Zn). The structure illustrates the open access of the porphyrins central metal ion.

FIG. 2 is a diagram illustrating the encapsulation of metalloporphyrins within the octahemicatohedral cages of HKUST-1. Also illustrated are the other cavities associated with the framework.

FIG. 3 is a normalized single crystal absorption spectra (derived from specular reflectance data) for M4SP@HKUST-1(Cu) (solid line), M4SP@HKUST-1(Zn) (dashed line) and solution optical spectrum (dotted line) for Fe(3+)4SP (top panel) and Mn(3+)4SP (bottom panel).

FIG. 4 is Representative kinetic traces for the reaction of Fe4SP@HKUST-1(Cu) with H₂O₂ and ABTS. Top Panel: Overlay of the catalytic traces for Fe4SP in ethanol (solid line), horse heart metMyoglobin (short dash, in 50 mM phosphate buffer, pH 6.5), Microperoxidase-11 (long dash, in 50 mM phosphate buffer, pH 6.5), 6 mg of HKUST-1(Cu) (long dash dash-dash), 4 mg of Fe4SP@HKUST-1 (dash dot dot) in ethanol. Bottom Panel: Overlay of kinetic traces for 4 mg of Fe4SP@HKUST-1(Cu) in the presence of ABTS and H₂O₂ and traces for three subsequent catalytic cycles.

FIG. 5 are powder X-ray diffraction (PXRD) patterns of calculated HKUST-1(Cu), experimental HKUST-1(Cu) (purple), and experimental Mn(3+)4SP@HKUST-1(Cu) as further described in Exampe 1. Powder patterns were obtained using a Bruker D8 ADVANCE, θ/2θ diffractometer using CuKα radiation (λ=1.54056 Å). 2θ scans between 3° and 40° with a step size of 0.02° were performed on a rotating platform for duration of fifteen minutes and twenty-six seconds.

FIG. 6 is an infrared spectra for HKUST-1(Cu), Mn(3+)4SP@HKUST-1(Cu), and Mn(3+)4SP_Cl. Spectra were recorded on a Nicolet Avatar 320 FT-IR spectrometer from 600 cm⁻¹ to 4000 cm⁻¹ by combining 32 scan with 4 cm⁻¹ resolution as described in Example 1. The region shown from 2000-600 cm⁻¹ details the fingerprint region in which peaks at 1032 cm⁻¹ and 1004 cm⁻¹ are observed in both Mn(3+)4SP_Cl and Mn(3+)4SP@HKUST-1(Cu) but not observed in HKUST-1(Cu).

FIG. 7 are nitrogen isotherms of HKUST-1(Cu) and Mn(3+)4SP@HKUST-1(Cu). Isotherms were recorded using a NOVA 2000 series Quantachrome instrument at 77 K.

### DETAILED DESCRIPTION OF THE INVENTION

In accordance with one aspect of the present invention, supramolecular host assemblies comprising a heterocyclic macrocycle guest are provided. The supramolecular assembly is polyhedral, comprising cubioctahedral, octahemioctahedral and trigonal cavities in a ratio of 1:1:2, respectively; stated differently, a unit cell of the supramolecular assembly comprises the cubioctahedral, octahemioctahedral and trigonal cavities in a ratio of 1:1:2.

The heterocyclic macrocycle guest molecule may be any of a wide range of natural or synthetic molecules having octahedral symmetry that may be hosted by the octahemioctahedral cavity of the supramolecular assembly. For example, in one embodiment, the heterocyclic macrocycle guest molecule is a porphyrin, a porphyrazin, a chlorin, a corrin, or a porphyrinogen. By way of further example, in one embodiment, the heterocyclic macrocycle guest molecule is a metalated porphyrin, a metalated porphyrazin, a metalated chlorin, a metalated corrin, or a metalated porphyrinogen.

The heterocyclic macrocycle guest molecule is hosted by a polyhedral metal-organic material assembled from metal ions and organic ligands. As described in greater detail elsewhere herein, the metal ions and organic ligands may be selected from a wide variety of materials that provide the desired polyhedral supramolecular assembly. More specifically, the metal ions and organic ligands are selected to provide a molecular framework comprising cubioctahedral, octahemioctahedral and trigonal cavities in a ratio of 1:1:2. The octahemioctahedral cavities may then be used to host the heterocyclic macrocycle guest molecule.

In general, the molecular building blocks are comprised of metals or metal clusters with three or more connection points (nodes) and they are coordinated to multi-functional exodentate organic ligands. If the organic ligands are bifunctional and their only role is to connect two adjacent nodes then they serve as “linkers” whereas polyfunctional ligands that connect three or more nodes also serve as nodes. In general, the cavities in the supramolecular assemblies will have the requisite shape, size and symmetry to encapsulate a particular metalated heterocyclic macrocycle and will have windows that allow ingress of reaction substrates and egress of reaction products.

The supramolecular assembly may be formed by combining a source of metal ions and organic ligands for the polyhedral molecular framework, and the heterocyclic macrocycle guest molecule in a solvent system. Reaction temperatures will typically be in the range of about 0 to 200° C. More typically, the reaction temperature will be in the range of about 20 to 120° C. Alternatively, or additionally, in some embodiments the reaction mixture may be microwaved to induce the formation of the supramolecular assembly.

The reaction mixture solvent system will typically comprise a suitable organic solvent. It may additionally comprise water. Exemplary organic solvents include, but are not limited to, aprotic dipolar solvents (such as acetone, acetonitrile, dimethylformamide, dimethylacetamide, dimethylsulfoxide, 1-methyl-2-pyrrolidinone, and the like), alcohols (such as methanol, ethanol, tert-butanol, isopropanol, and the like), combinations thereof, and the like. Preferred reaction mixture solvent systems comprise dimethylacetamide (“DMA”), dimethylformamide (“DMF”), and/or “DEF” with or without water.

In accordance with one embodiment and as an example of the present invention, we describe herein a class of metal organic materials that mimic heme enzymes in terms of both structure and reactivity. The MOMzyme-1 class (Metal Organic Material enzyme) is based upon a prototypal MOM, HKUST-1, into which catalytically active metalloporphyrins are selectively encapsulated “ship-in-a-bottle” fashion within one of the three polyhedral cages that exist in HKUST-1. MOMs offer un-paralleled levels of permanent porosity and their modular nature affords enormous diversity of structures and properties. The MOMzyme-1 class therefore represents a new paradigm for heme biomimetic catalysis since it combines the activity of a homogeneous catalyst with the stability and recyclability of heterogeneous catalytic systems within a single material.

The catalytic diversity of heme proteins is an ongoing target for biomimetic chemistry and a wide array of systems have been developed to capture the salient catalytic features of heme proteins with limited success including porphyrin encapsulated sol-gels^{12,13}, clay-like layered materials^{14,15}, synthetic zeolites^{16,17}, detergent micelles¹⁸, and polymer films.^{19,20} Although these materials exhibit catalytic activity reminiscent of heme proteins they lack structurally tunable distal and proximal heme pockets limiting their usefulness in heme biomimetic chemistry. In the case of MOMs, we have previously demonstrated that it is possible to encapsulate free base and metallated cationic porphyrins into the large cages of a zeolite-like metal organic framework (rhoZMOF) using a ‘ship-in-a-bottle’ approach.²¹ Although this system exhibited limited biomimetic activity towards mono-oxygenation the porphyrin lacked orientational specificity. Thus this system did not posses the requisite distal and proximal heme pockets found in proteins. This effort inspired the current system in which selective encapsulation of catalytically active porphyrins within specific cages associated with the HKUST-1 framework has been achieved thereby creating functionalizable and orientationaly specific proximal and distal heme pockets as well as substrate selective access channels to and from the porphyrin active sites. As such, the new materials retain many of the critical catalytic features associated with heme enzymes and promise the potential for the development of bio-inspired materials spanning a wide range of catalytic chemistry.

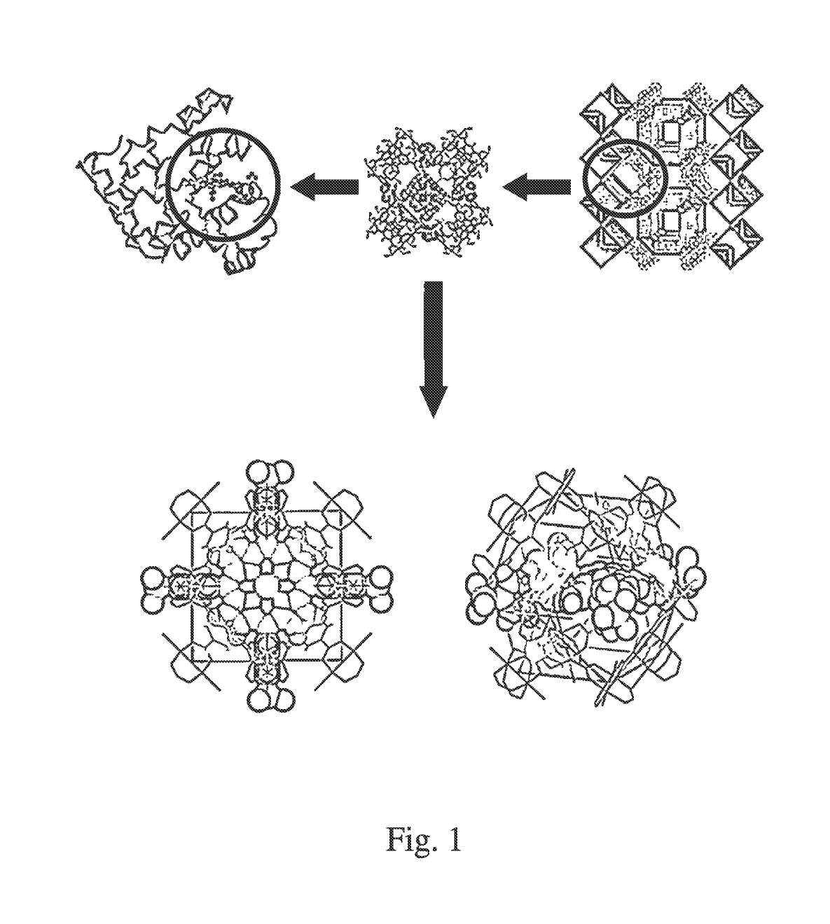

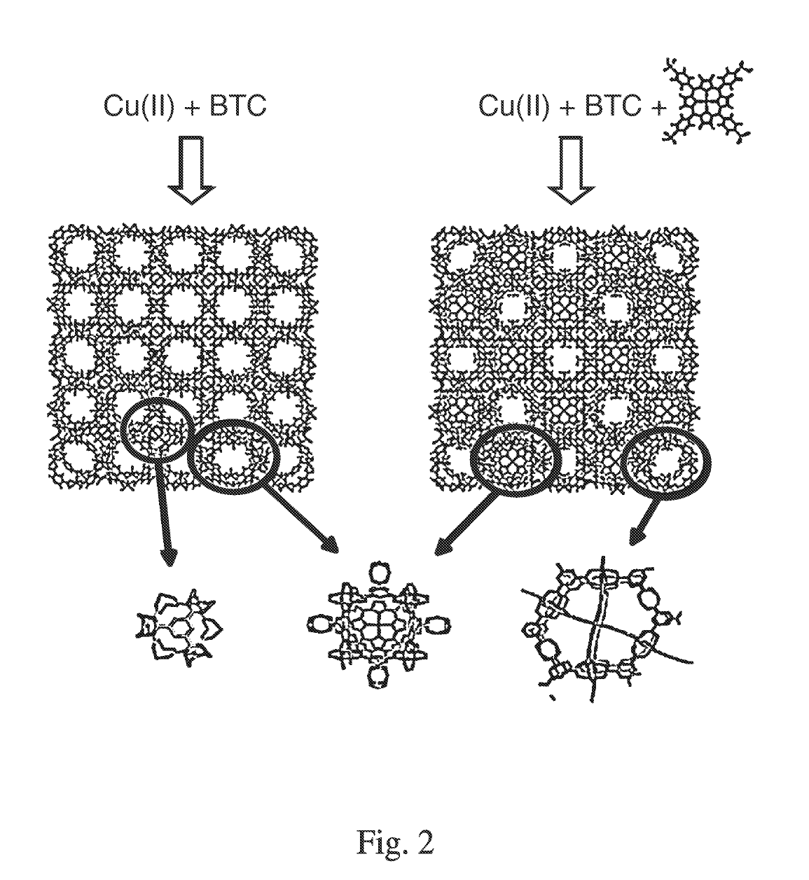

HKUST-1, formed through the assembly of benzene-1,3,5-tricarboxylate anions and copper(II)²² or zinc(II)²³ cations, is well-suited to serve as a platform for heme biomimetic chemistry since its topology affords three distinctly different polyhedral cages capable of entrapping guest molecules (FIG. 1, top right and bottom and FIG. 2). Indeed HKUST-1 selectively encapsulates polyoxometallate anions and exhibits size selective catalysis of ester hydrolysis.²⁴ In the case of the MOMzyme-1 systems reported herein, a metalloporphyrin (either Fe(3+)tetrakis(4-sulphonatophenyl)porphyrin, Fe4SP, or Mn(3+)tetrakis(4-sulphonatophenyl)porphyrin, Mn4SP) has been encapsulated within the octahedral cage that is most suited to serve as a host for a metalloporphyrin based upon cage size and symmetry (FIG. 1, bottom middle) while the remaining cavities allow small molecules to reach the active site for catalysis much like channels in heme proteins. The new materials are designated Fe4SP@HKUST-1(Cu or Zn) or Mn4SP@HKUST-1(Cu or Zn). Crystal structures of these MOMzymes were determined through single-crystal x-ray diffraction and were found to be isostructural with HKUST-1 (See Supplemental information for full details). These structures have the porphyrin benzenesulfonic acid peripheral groups oriented through four of the six square windows of the octahemioctahedral cages (FIG. 1). It is this penetration of the benzenesulfonic acid groups of the porphyrin into neighboring cages that locks the porphyrin into a well defined orientation within the cage. The axial sites on both planes of the porphyrin are therefore necessarily exposed to the access channels of the framework since they lie directly above and below the other two square windows of the cage (FIG. 1). The porphyrin ring can occupy one of three equivalent orientations within the cavity due to cavity symmetry (FIG. 1). Although the porphyrin ring in each cavity posses a specific orientation, the orientations between cavities varies leading to static (as opposed to dynamic) disorder throughout the crystal. The porphyrin planes are clearly resolvable as the D₄ₕ symmetry of the porphyrin's core is a subgroup of the cage symmetry and the core is located on the symmetry plane and axes. The porphyrin loading was estimated using both X-ray data (site occupancy refinement of metal atom) and spectroscopically (see Supplemental information) to be between 33% and 66% depending on reaction conditions suggesting that ⅓ to ⅔ of octahemioctahedral cages are occupied by porphyrin. The extent of porphyrin loading can be controlled by the amount of porphyrin present during the synthesis. The maximal loading was found to be ˜66% (cavity loading) at saturating porphyrin concentrations. The presence of porphyrin molecules in the HKUST-1 framework reduces the experimentally observed surface area after activation at 85° C. in vacuo from 1663 m²/g for HKUST-1(Cu) to 980 m²/g for the Mn(3+)4SP HKUST-1(Cu).

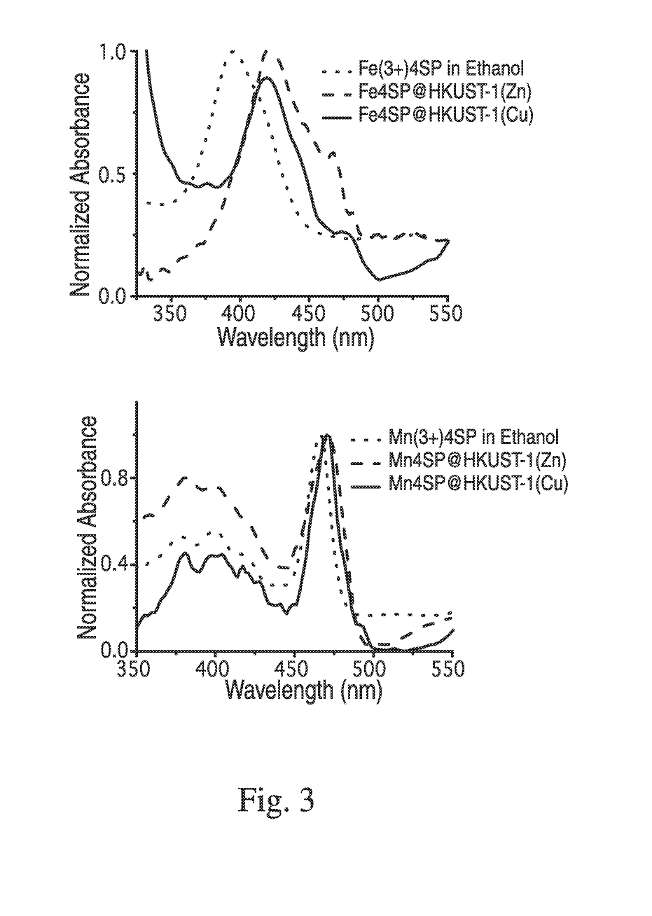

The optical spectrum of metallopophyrins provides important information regarding oxidation and spin state of the central metal, the hydrophobicity of the macrocycle pocket and the metallation state of the porphyrin. The single crystal optical absorption spectra (derived from specular reflectance data) of both Fe4SP@HKUST-1(Cu or Zn) or Mn4SP@HKUST-1(Cu or Zn) are displayed in FIG. 3. The spectra of Fe4SP@HKUST-1(Cu or Zn) exhibits a Soret maximum at ˜419 nm while the corresponding Soret maximum of Fe(3+)4SP in buffer-ethanol solution is found to be 394 nm (characteristic of six coordinate high-spin ferric iron). The bathochromic shift of the encapsulated Fe(3+)4SP in the MOMzyme frameworks is similar to that of Fe(3+)4SP in the presence of zwitterionic surfactants where the Soret maximum shifts to ˜416 nm.²⁵ Thus, the spectral results are consistent with the encapsulated Fe(3+)4SP retaining a six coordinate high-spin ferric iron experiencing a more hydrophobic environment relative to aqueous solution. The optical spectra of the Mn4SP@HKUST-1(Cu, Zn) also display a slight bathochromic shift of the Soret band relative to that of the porphyrin solution (467 nm for Mn(3+)4SP in solution versus ˜471 nm for the Mn4SP@HKUST-1(Cu, Zn)) also consistent with the hydrophobic nature of the HKUST-1 cavity. The fact that the single crystal optical spectra of the encapsulated porphyrins are nearly identical between M4SP@HKUST-1(Cu) and M4SP@HKUST-1(Zn) (M=Fe(3+) or Mn(3+)) indicate that the electrostatic environment of the binding pockets is similar between the two frameworks.

One of the most important catalytic reactions performed by heme proteins is monooxygenation of organic substrates.^{26,27} The general mechanism for heme monoxygenation proceeds through a high-valent Fe(IV)═O intermediate which is highly oxidizing. This intermediate can be arrived at through either a ferrous heme in the presence of molecular oxygen (e.g., cytochrome P450 (CYP) class of proteins) or through ferric enzymes in the presence of a peroxide (e.g., peroxidase class of heme enzymes).

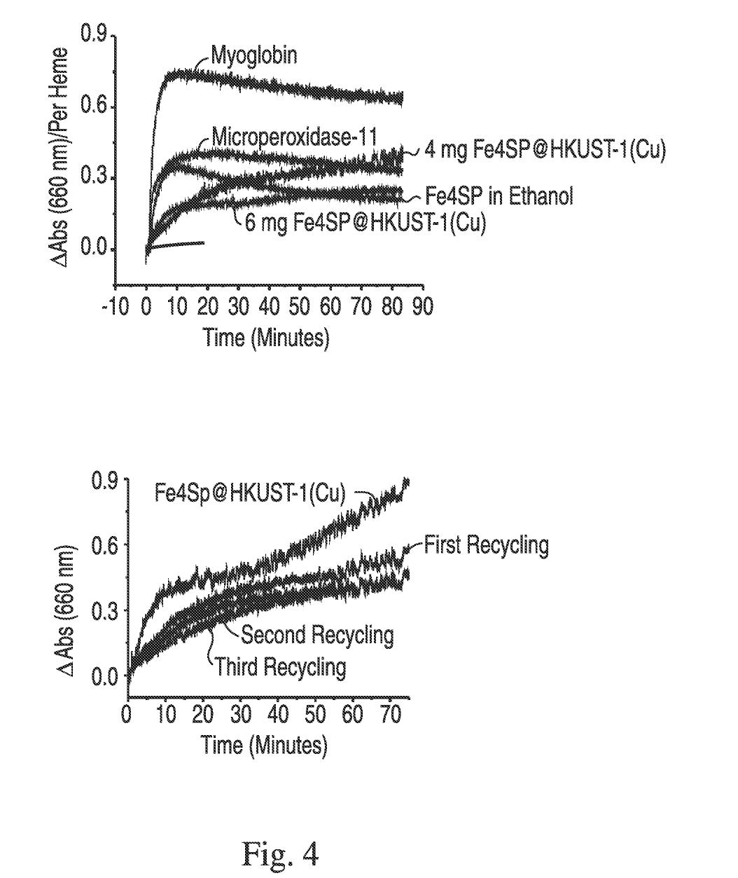

As a probe for heme protein biomimetic capacity of the new MOMzymes, the peroxidase activity of the material was assayed using 2,2′ azinodi(3-ethylbenzthiazoline)-6-sulfonate (ABTS) as a redox indicator by monitoring the rate of increase in absorbance at 660 nm (ε=12 mM⁻¹ cm⁻¹ for ABTS^{+•}) subsequent to the addition of peroxide.²⁷ The results of the assay are summarized in Table 1 and FIG. 4 and are compared to the catalytic activity of microperoxidase-11 (MP-11), horse heart myoglobin (hhMb) and Fe4SP in solution. The data reported in Table 1 indicate that the initial rate for ABTS^{+•} formation by the Fe4SP@HKUST-1(Cu) material is lower than observed for MP-11, hhMb or Fe4SP (all in solution) while the maximum yield of ABTS^{+•}, relative to hhMb, is comparable to that of MP-11 and Fe4SP in solution. The hhMb, MP-11 and Fe4SP were selected as preliminary bench-mark systems as each displays peroxidase activity with increasing levels of structural complexity.

TABLE 1
Summary of kinetic results for the degradation of
H₂O₂ by the Fe4SP@HKUST-1(Cu) materials and model systems

| | Rate of H₂O₂ | % [ABTS] |
|---|---|---|
| | Degradation | Converted |
| | (μM ABTS s⁻¹ | per mole of Heme |
| Material | μM⁻¹ of Heme) | (relative to hhMb) |
| Met Horse Heart Myoglobin | 3.2 | 100 |
| (solution) | | |
| Microperoxidase-11 | 3.6 | 52 |
| (solution) | | |
| Fe4SP (solution) | 1.1 | 50 |
| HKUST-1(Cu) | 0 | 0 |
| 6 mg Fe4SP@HKUST-1(Cu) | 0.3 | 50 |
| 4 mg Fe4SP@HKUST-1(Cu) | 0.3 | 41 |
| Fe4SP@HKUST-1(Cu) | 0.1 | 60 |
| Once Recycled | | |
| Fe4SP@HKUST-1(Cu) | 0.09 | 55 |
| Three Recyclings | | |

The lower initial rate for ABTS^{+•} formation, relative to the three bench-mark systems, is due to the fact that substrate molecules must diffuse into/out of the channels of the HKUST-1(Cu) framework within the bulk material. However, % ABTS conversion is comparable to both MP-11 and Fe4SP. The significant percent conversion demonstrates several important features of the new material: 1) the axial positions of the encapsulated porphyrins are accessible to small molecules diffusing from solution into the HKUST-1(Cu) framework, 2) the Fe4SP remain catalytically active within the framework, 3) the larger ABTS substrate still has access to the encapsulated active sites and 4) successive turnovers can take place without significant degradation of the porphyrin macrocycles (in contrast to free Fe4SP or hhMB in solution).

One of the most significant limitations of homogeneous catalysts involving monooxygenation is the survivability of the catalyst. For metalloporphyrin systems, the intermediates present during catalysis (both ferryl and porphyrin Π^{•+} in the case of iron porphyrin) are reactive and interact with other porphyrin macrocycles in solution thus rendering them inactive. In the case of proteins such as hhMb, excess H₂O₂ results in protein cross-linking and heme inactivation after successive turnovers. The ability of the Fe4SP@HKUST-1(Cu) material to isolate the catalytic centers within cavities and minimize catalytic degradation is illustrated in Table 1 (and FIG. 4). Recovery and recycling results in retention of ˜33% of the initial rate of ABTS^{•+} formation while the maximal production of ABTS^{+•} remains at ˜66% of the initial catalysis run after three rounds of catalyst recycling (catalytic run-collection, washing and drying of the crystalline material followed by the next catalytic cycling). The initial loss of activity is likely due to the presence of guest molecules within the framework (possibly solvent or solvent breakdown products) that degrade the porphyrin catalyst but are consumed during the initial turnover cycle. No significant reduction in catalyst activity or percent ABTS conversion is observed after the initial catalytic cycle.

Whereas HKUST-1 type nets provide the platforms for the pro-totypal MOMzymes described herein, it is unlikely that they are the only nets suitable for porphyrin encapsulation or that they will offer optimal performance. There already exists a plethora of existing MOMs⁷ that are based upon polyhedral building blocks and many of these materials exhibit higher surface area and pore size. The prototypal MOMzymes described herein suggest the feasibil-ity of custom-designing the right MOM for the right substrate and the right metalloporphyrin combination. For example, the proximal and distal heme pockets within the MOMzyme could be func-tionalized through derivatization of the organic linkers making up the MBBs or through modification of the porphyrin ring. In addition, the dimensionality of the substrate access channels can also be modulated through the design of the organic linkers. The ability to functionalize the discrete porphyrin cavities provides an opportunity to develop unique solid state MOMzyme type materials that can span the range of heme protein catalytic chemistry including the extensive range of stereo specific monooxygenation reactions associated with the cytochrome P450 class of enzymes, dioxygen reduction (cytochrome oxidase-like single crystal fuel cells), nitric oxide production, and even photo-activated direc-tional electron transfer (artificial photosynthesis).

Organic Ligands

As previously noted, the organic ligands generally serve as linkers or nodes in the metal organic material framework of the supramolecular assembly of the present invention. In general, the organic ligands are linear, branched or cyclic and polyvalent to coordinate with metals (including metal ions and metal oxides). Typically, the organic ligands will be linear, branched, monocyclic, bicyclic or tricyclic and contain at least two coordinating groups. For example, in one embodiment, the organic ligand is a linker, containing two metal coordinating groups. In other embodiments, the organic ligand is a node, containing at least 3 metal coordinating groups. In other embodiments, the organic ligand is a node, containing at least 4 metal coordinating groups. In other embodiments, the organic ligand is a node, containing at least 6 metal coordinating groups. In other embodiments, the organic ligand is a node, containing at least 8 metal coordinating groups. In other embodiments, the organic ligand is a node, containing at least 12 metal coordinating groups. In other embodiments, the organic ligand is a node, containing at least 24 metal coordinating groups.

In one embodiment, the ligand compound corresponds to Formula (1):

R₁-L₁-AL₃-R₃)ₙ (1)

wherein

A is a bond or a monocyclic ring or polycyclic ring system;

L₁ and each L₃ is a linker moiety;

n is at least 1; and

R₁ and each R₃ is independently a functional group capable of coordinately bonding to at least one metal ion.

In one exemplary embodiment, the organic ligand corresponds to Formula 1, n is 1, A is a bond, L₁ and L₃ are linkers, and the organic ligand contains two metal coordinating groups, R₁ and R₃.

In another exemplary embodiment, n is 1 or 2, A is a monocyclic or polycyclic ring system, L₁ and L₃ are linkers, and the organic ligand contains one R₁ metal coordinating groups and one or two R₃ metal coordinating groups. In general, when A is a ring system, the A ring system may comprise any saturated or unsaturated carbocyclic or heterocyclic ring structure. The A ring may be monocyclic, or may be a bicyclic, tricyclic, hexacyclic, or otherwise polycyclic ring system, provided that the polycyclic ring system is capable of being substituted in the manner described and illustrated in connection with Formula 1. In one embodiment in which the A ring is a polycyclic ring system, the A ring has the structure:

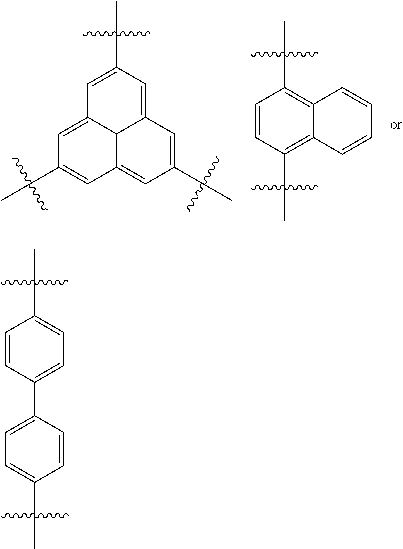 [SMILES: *C1=CC2=CC(*)=CC3=CC(*)=CC(=C1)C23 ; *c1ccc(*)c2ccccc12 ; *c1ccc(-c2ccc(*)cc2)cc1]

wherein the wavy lines represent the attachment point of the A ring to the remainder of the ligand compound (i.e., at L₁ and L₃) of each substituent arm).

In certain embodiments, A is a six-membered ring moiety. In general, the six-membered A ring may be any saturated or unsaturated six-membered carbocyclic or heterocyclic ring structure. Cationic forms of the carbocyclic or heterocyclic A ring are also contemplated; that is, a free electron pair of a carbon or heteroatom may be involved in the skeletal bonding of the ring system, e.g., in the formation of the ring or in the double bond system of the ring.

In one embodiment, A ring is a six-membered carbocyclic or heterocyclic ring having the structure:

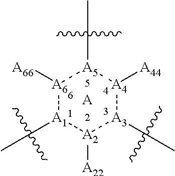

wherein

the atoms defining the ring, A₁, A₂, A₃, A₄, A₅, and A₆, are independently selected from carbon, nitrogen, oxygen, boron, and sulfur atoms (including cations thereof);

the A₁, A₃, and A₅ ring atoms are substituted with the -L₁-R₁, and -L₃-R₃ ring moieties (as described in connection with Formula (1);

A₂₂, A₄₄, and A₆₆ are independently -L₃-R₃ (as previously defined in connection with Formula 1) or any atom or group of atoms that do not otherwise affect the substituent arms;

the dashed lines represent single or double bonds, or collectively form a conjugated bond system that is unsaturated to a degree of aromaticity; and

the wavy lines represent the attachment point of the A ring to the remainder of the ligand compound (i.e., at L₁ or L₃ of each substituent arm).

In general, the A₂₂, A₄₄, and A₆₆ substituents are selected such that they will not adversely affect other substituents on the ligand compound and/or will not affect assembly of the desired ligands and further assembly of the molecular building blocks. Suitable substituents for A₂₂, A₄₄, and A₆₆ include, for example, one or more of the following chemical moieties: —H, —OH, —OR, —COOH, —COOR, —CONH₂, —NH₂, —NHR, —NRR, —SH, —SR, —SO₂R, —SO₂H, —SOR, and halo (including F, Cl, Br, and I), wherein each occurrence of R may be hydrocarbyl or substituted hydrocarbyl (e.g., substituted or unsubstituted alkyl, substituted or unsubstituted aryl, or substituted or unsubstituted araklyl). Alternatively, one or more of A₂₂, A₄₄, and A₆₆ may be -L₃-R₃ (as previously defined in connection with Formula 1).

In one embodiment, n is 1 or 2 and A is a six-membered aromatic ring. Alternatively, the A ring may be a six-membered non-aromatic ring. In one embodiment, for example, the six-membered A ring is selected from benzene, pyridine, pryridinium, pyrimidine, pyrimidinium, triazine, triazinium, pyrylium, boroxine, diborabenzene, and triborabenzene rings. Thus, for example, when n is 1 or 2 the A ring may correspond to one of the following exemplary six-membered rings:

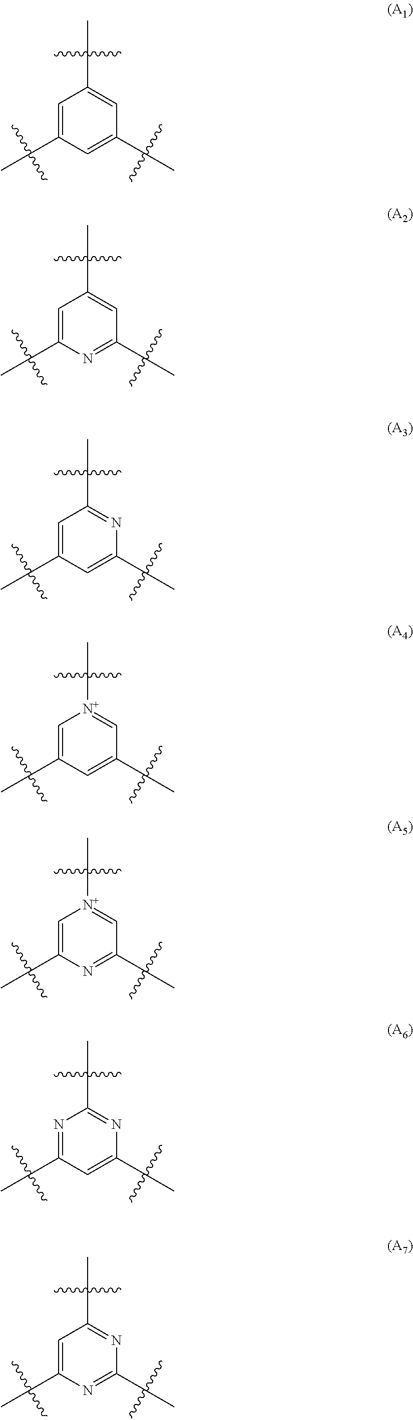

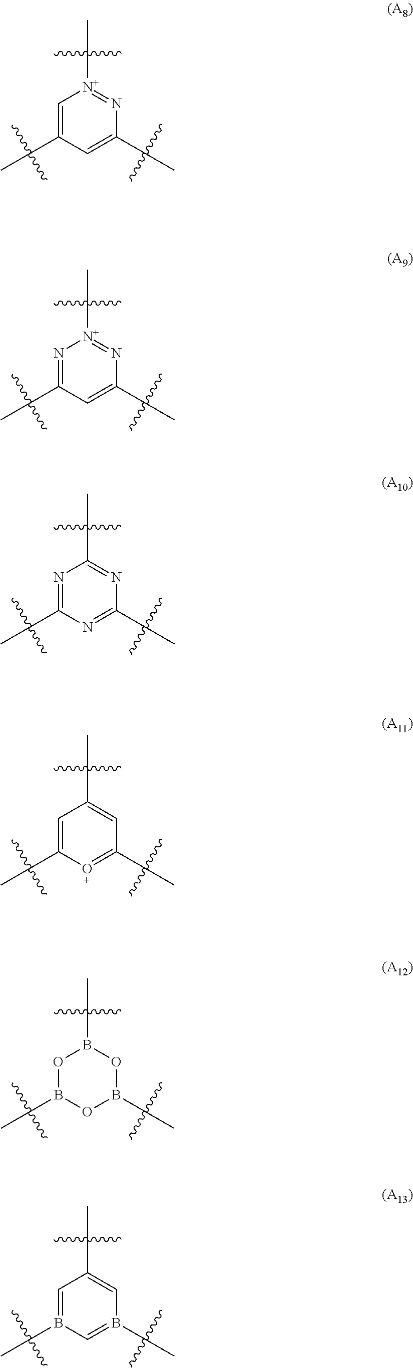

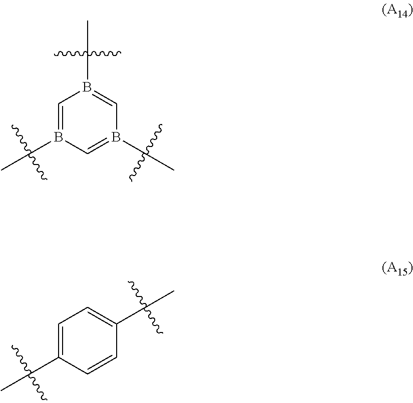

wherein the wavy lines represent the attachment point of the A ring to the remainder of the ligand compound corresponding to Formula (1) (i.e., at L₁ or L₃ of each substituent arm).

In one embodiment, n is 1 or 2, and A is a six-membered benzene, boroxine, pyridyl or triazine ring. According to this embodiment, therefore, the A ring is selected from:

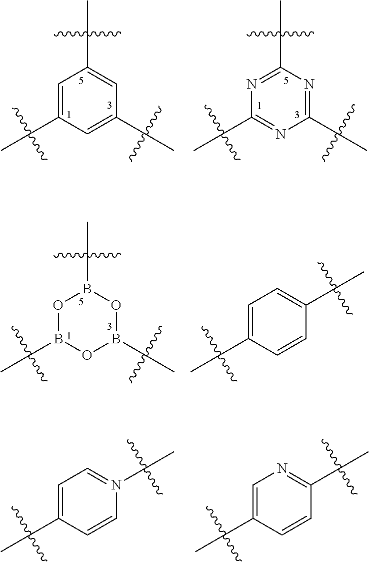

wherein the wavy lines represent the attachment point of the A ring to the remainder of the ligand compound corresponding to Formula (1) (i.e., at L₁ or L₃ of each substituent arm). In one preferred embodiment, A ring is a benzene ring. According to this embodiment, therefore, the A ring has the formula:

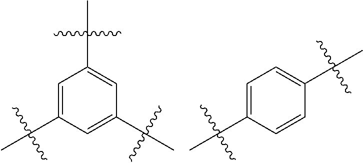 [SMILES: *c1cc(*)cc(*)c1 ; *c1ccc(*)cc1]

wherein the wavy lines represent the attachment point of the benzene ring to the remainder of the ligand compound corresponding to Formula (1) (i.e., at L₁ or L₃ of each substituent arm).

In one embodiment, the organic ligand corresponds to Formula 1 and n is 1. In another embodiment, n is 2. In another embodiment, n is 3. In another embodiment, n is 4. In another embodiment, n is at least 6. In another embodiment, n is at least 8. In another embodiment, n is at least 12. In another embodiment, n is at least 24.

The ligand compounds of Formula (1) also possess the L₁ and L₃ linking moieties, which join the R₁ and R₃ substituents to the A moiety. In each of the ligand compounds described herein, the L₁ and L₃ linking moieties may comprise covalent bonds, coordinate covalent bonds, noncovalent bonds, or a combination thereof. In certain embodiments, L₁ and/or each L₃ comprise direct chemical bonds. In certain other embodiments, L₁ and/or each L₃ may comprise organic linking moieties. In still other embodiments, L₁ and each L₃ may independently comprise coordinating bonds.

In general, the dimension, pore size, free volume, and other properties of the molecular building blocks and metal-organic frameworks including the ligands described herein can be correlated to the linker moieties, L₁ and L₃ of the ligand compound. For example, expanded structures can result from expanding the series of linkers (e.g., as a series of phenylene moieties), and the pore size can be reduced by the selection of functional groups on the linkers that point towards the inner cavities of the building blocks. In addition, other functional properties of the resulting building blocks can be selected by the appropriate selection of substituents (e.g., fluorescent or catalytic moieties) on the linking subunits.

The L₁ and L₃ linking moieties are generally the same and link the R₁ and R₃ substituents to the A moiety at the 1 and 3 positions, respectively.

Typically, L₁ is a bond or -(L₁₁)ₘ-, wherein L₁₁ is heterocyclene, hydrocarbylene, or substituted hydrocarbylene and m is a positive integer, L₃ is a bond or -(L₃₃)ₘ-, wherein L₃₃ is hydrocarbylene or substituted hydrocarbylene and n is a positive integer, with L₁ and L₃ being the same, and m is a positive integer. In one particular embodiment, L₁ and L₃ are each bonds.

Where L₁ and/or L₃ are -(L₁₁)ₘ- and -(L₃₃)ₘ-, respectively, although L₁₁ and L₃₃ may be heterocyclene, hydrocarbylene, or substituted hydrocarbylene, in certain embodiments L₁₁ and L₃₃ are substituted or unsubstituted alkylene, alkenylene, alkynylene, arylene, or heterocyclene. Where L₁₁ and L₃₃ are alkylene or alkenylene, for example, they may be straight, branched, or cyclic, preferably straight or cyclic. The L₁₁ and L₃₃ moieties may also be alkynyl, such as ethynyl. In one preferred embodiment, L₁ and L₃ are -(L₁₁)ₘ- and -(L₃₃)ₘ-, respectively, wherein L₁₁ and L₃₃ are substituted or unsubstituted alkylene, alkynyl, substituted or unsubstituted arylene, or heterocyclene.

In a particularly preferred embodiment, L₁ and L₃ are each bonds or are -(L₁₁)ₘ- and -(L₃₃)ₘ-, respectively, wherein L₁₁ and L₃₃ correspond to one of the following structures:

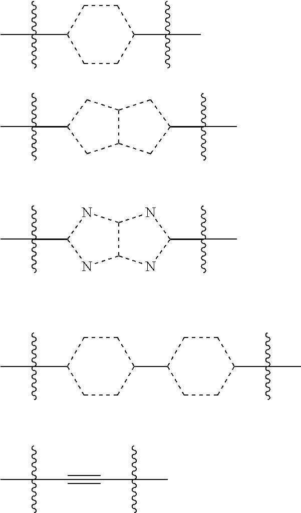

wherein

the dashed lines represent single or double bonds, or collectively form a conjugated bond system that is unsaturated to a degree of aromaticity;

the wavy lines represent the attachment point of the L₁₁ or L₃₃ moiety to the A moiety and another L₁₁ or L₃₃ moiety (i.e., when m is 2 or more) or to the A moiety and R₁ or R₃; and

each m is a positive integer.

In another preferred embodiment, L₁ and L₃ are each bonds or are -(L₁₁)ₘ- and -(L₃₃)ₘ-, respectively, wherein L₁₁ and L₃₃ are substituted or unsubstituted arylene; more preferably in this embodiment, L₁₁ and L₃₃ are substituted or unsubstituted phenylene.

Where L₁₁ and/or each L₃₃ is substituted hydrocarbylene (e.g., substituted alkylene or substituted arylene, more preferably substituted phenylene), the substituents may be any of a variety of substituents to impart a desired effect or property to the ligand compound, molecular building block, or the resulting supramolecular building block or metal-organic framework comprising such ligands and building blocks. As noted above, the substituent(s) for the linker moieties may be selected to impart various desired properties, such as magnetic activity, luminescent activity, phosphorescent activity, fluorescent activity, and catalytic and redox activity to the building blocks and assembled structures comprising these components. Exemplary substituents which may be found on the substituted alkylene or substituted arylene (e.g., substituted phenylene) moieties of L₁₁ and L₃₃ include, but are not limited to, one or more of the following chemical moieties: —OH, —OR, —COOH, —COOR, —CONH₂, —NH₂, —NHR, —NRR, —SH, —SR, —SO₂R, —SO₂H, —SOR, and halo (including F, Cl, Br, and I), wherein each occurrence of R may be hydrocarbyl or substituted hydrocarbyl (e.g., substituted or unsubstituted alkyl, substituted or unsubstituted aryl, or substituted or unsubstituted araklyl).

Although L₁₁ and L₃₃ are generally the same, when these moieties are substituted hydrocarbylene they may not necessarily carry the same substituents on each hydrocarbylene moiety. For instance, L₁₁ may be substituted phenylene carrying a particular halo substituent (e.g., F, Cl, Br, and/or I), or a combination thereof, while L₃₃ may be substituted phenylene carrying a different halo substituent (or a different combination of halo substituents), or different substituents altogether (e.g., —OH or NH₂). Thus, in various embodiments L₁₁ and L₃₃ are independently:

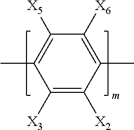

wherein m is a positive integer and each X₂, X₃, X₅, and X₆ is independently —H, —OH, —OR, —COOH, —COOK, —CONH₂, —NH₂, —NHR, —NRR, —SH, —SR, —SO₂R, —SO₂H, —SOR, or halo. In these and other embodiments, L₅₅ may be:

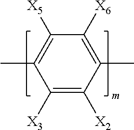

wherein m is a positive integer and each X₂, X₃, X₅, and X₆ is independently —H, —OH, —OR, —COOH, —COOK, —CONH₂, —NH₂, —NHR, —NRR, —SH, —SR, —SO₂R, —SO₂H, —SOR, or halo. The substituents on a substituted hydrocarbylene L₅₅ moiety may be the same or different from those of a substituted or unsubstituted hydrocarbylene L₁₁ and/or L₃₃ moiety.

Where L₁ and L₃ are -(L₁₁)ₘ- and -(L₃₃)ₘ- respectively, the number of L₁₁ and L₃₃ repeat units, m, is a positive integer. As noted above, L₁ and L₃ are generally the same, so the number of repeat units, m, for these moieties will be the same. The number of repeat units for L₅₅, however, may be the same or different than the number of repeat units for the L₁₁ and L₃₃ moieties. Generally speaking, compounds carrying more than ten (10) L₁₁ and/or L₃₃ repeat units tend to be less desired, as the substituent arms can lose rigidity and lack the proper orientation for assembly into larger molecular and molecular building blocks and metal-organic frameworks. Typically, where present, each m is 1 to 10 (e.g., 1, 2, 3, 4, 5, 6, 7, 8, 9, or 10). In one embodiment, L₁ and L₃ are -(L₁₁)ₘ- and -(L₃₃)ₘ-, respectively, wherein L₁₁ and L₃₃ are substituted or unsubstituted phenylene and each m is 1, 2, 3, 4, or 5; more preferably, each m is 1, 2, or 3.

In addition to the A moiety, L₁ and L₃, the ligand compound corresponding to Formula (1) carries the R₁ and R₃ substituents. Generally, the R₁ and R₃ substituents are functional groups capable of coordinately bonding to at least one metal (including metal ions and metal oxides). The functional groups for R₁ and R₃ are preferably at least bidentate, and may be tridentate, or otherwise polydentate. In one embodiment, R₁ and R₃ are bidentate functional groups.

In particular, the R₁ and R₃ groups are capable of coordinately bonding to at least one metal (including metal ions and metal oxides) and typically at least two metals (which may be either the same or different) to form the molecular building block. Thus, for example, while the R₁ and R₃ groups may be initially be a functional group, when combined with metal(s) in the formation of the molecular building block the R₁ and R₃ groups become coordinating groups with the metal ions or oxides.

Representative functional groups capable of coordinately binding to at least one metal include, but are not limited to, the following: —CO₂H, —CS₂H, —NO₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(SH)₂, —C(SH)₃, —CH(NH₂)₂, —C(NH₂)₂, —CH(OH)₂, —C(OH)₃, —CH(CN)₂ and —C(CN)₃, —CH(RSH)₂, —C(RSH)₃, —CH(RNH₂)₂, —C(RNH₂)₃, —CH(ROH)₂, —C(ROH)₃, —CH(RCN)₂, and —C(RCN)₃, wherein each R is independently an alkyl or alkenyl group having from 1 to 5 carbon atoms, or an aryl group consisting of 1 to 2 phenyl rings. Other functional groups capable of coordinately binding to at least one metal include, but are not limited to, nitrogen donors such as, for example, cyano (—CN), amino, pyrazole, imidazole, pyridine, and functional groups containing such moieties. See, e.g., Tominaga et al., Angew. Chem. Int. Ed. 2004, 43, 5621-5625.

In one preferred embodiment, R₁ and R₃ are carboxylic acid (−CO₂H) groups. According to this embodiment, when the organic ligand is combined with one or more metals during the formation of a molecular building block, the carboxylic acid moieties become carboxylate moieties which coordinately bond with two metals in the following (bidentate) manner:

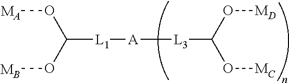

wherein n is at least 1, M_{A} and M_{B} and each M_{C} and M_{D} are metal ions (including metal oxides) and the dashed lines represent coordination bonds, with other coordination being possible with the metals and other moieties not specifically illustrated (e.g., between M_{A} and M_{B}, between M_{C} and M_{D}, and/or between M_{A}, M_{B}, M_{C}, and/or M_{D} an other moieties (for example, additional ligand compounds)), and the A moiety, L₁ and L₃ are as defined in connection with Formula (1) above.

In one embodiment, the organic ligand corresponds to Formula (1) and contains at least carboxylate moieties, at least two heteroaromatic amine moieties, or at least two phenoxy moieties. Alternatively, the organic ligands may contain combinations of at least one carboxylate moiety, at least one heteroaromatic amine moiety, and/or at least one phenoxy moiety.

In one embodiment, the organic ligand is a trigonal ligand corresponding to the following (schematic) structure:

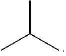

Examplary trigonal ligands include, monocyclic and polycyclic ligands as depicted below:

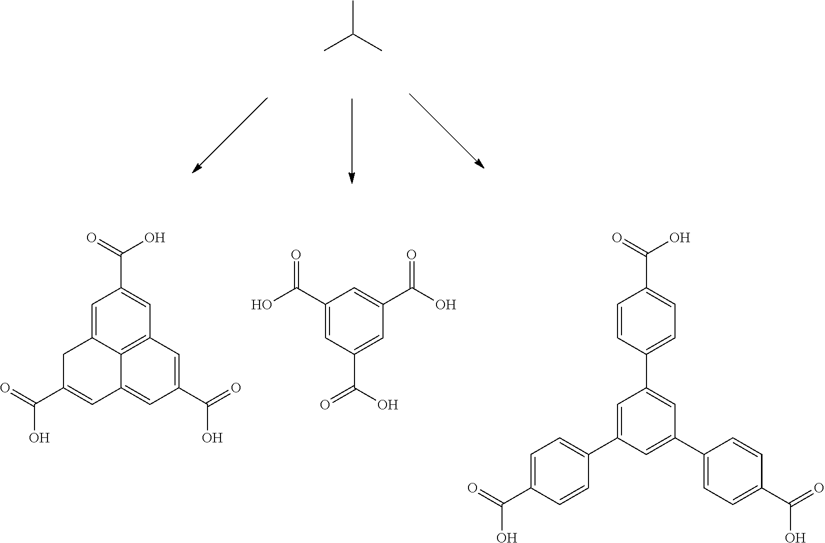

For ease of illustration, the trigonal ligands comprise carboxylic acid groups as the metal coordinating groups. In accordance with the present invention, other metal coordinating groups may be substituted for one, two or even all three of the illustrated metal coordinating groups.

Metals

As discussed above, the metal organic materials of the present invention comprise molecular building blocks, derived from the metal and organic ligands, and cavities enclosed by the molecular building blocks, in which a metalated heterocyclic macrocycle, such as a metalated porphyrin, resides. The metals comprised by the molecular building blocks and the metals comprised by the metalated heterocyclic macrocycles may be the same or different. In one embodiment, they are the same. In another embodiment, they are different. In yet another embodiment, the molecular building blocks comprise organic ligands coordinating two or more different metals.

In general, the organic ligands of the molecular building blocks can coordinate with metal ions from Groups 1, 2, 3, 4, 5, 6, 7, 8, 9, 10, 11, 12, 13, 14, 15, and 16 (according to the IUPAC Group numbering format) or Groups IA, IIA, IIIB, IVB, VB, VIIB, VIIB, VIII, IB, IIB, IIIA, IVA, VA, and VIA (according to the Chemical Abstracts Service (CAS) numbering format) of the periodic table. This includes, for example, metal ions from the alkali metals, alkaline earth metals, transition metals, Lanthanides, Actinides, and other metals. In order to form building blocks of the desired shape and orientation, a metal ion is selected having the appropriate coordination geometry (e.g., linear, trigonal planar, tetrahedral, square planar, trigonal bipyramidal, square pyramidal, octahedral, trigonal prismatic, pentagonal bipyramidal, cubic, dodecahedral, hexagonal bipyramidal, icosahedron, cuboctahedron, etc.).

The bond angle between the ligands and the metal ion generally dictates the topology of the molecular building block, while the functional groups on the ligands coordinate with metal ions to form the molecular building block. For example, in one embodiment the molecular building block is triangular and the metal ions are transition metals. In one particular embodiment, the molecular building block metal ions are selected from first row transition metals. In another particular embodiment, the molecular building block metal ions are selected from second row transition metals. In another particular embodiment, the molecular building block metal ions are selected from third row transition metals. In another embodiment, molecular building block metal ions are selected from the group consisting of Ag⁺, Al³⁺, Au⁺, Cu²⁺, Cu⁺, Fe²⁺, Fe³⁺, Hg²⁺, Li⁺, Mn³⁺, Mn²⁺, Nd³⁺, Ni²⁺, Ni⁺, Pd²⁺, Pd⁺, Pt²⁺, Pt⁺, Tl³⁺, Yb²⁺ and Yb³⁺, along with the corresponding metal salt counterion (if present). In one preferred embodiment, molecular building block metal ions are the same and are selected from the group consisting of Ag⁺, Au⁺, Cu²⁺, Cu⁺, Fe²⁺, Fe³⁺, Hg²⁺, Li⁺, Mn³⁺, Mn²⁺, Ni²⁺, Ni⁺, Pd²⁺, Pd⁺, Pt²⁺, and Pt⁺, along with the corresponding metal salt counterion (if present). In another preferred embodiment, molecular building block metal ions are copper, chromium, iron or zinc ions along with the corresponding metal salt counterion (if present). Suitable counterions include, for example, F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, and CO₃²⁻.

In another embodiment, the molecular building block has square pyramidal geometry and the metal ions are transition metals. For example, in one such embodiment, the molecular building block metal ions are first row transition metals. In another such embodiment, the molecular building block metal ions the metal ions are second row transition metals. In another such embodiment, the molecular building block metal ions are third row transition metals. In another such embodiment, the molecular building block metal ions are selected from the group consisting of Al³⁺, Bi⁵⁺, Bi³⁺, Bi⁺; Cd²⁺, Cu²⁺, Cu⁺, Co³⁺, Co²⁺, Cr³⁺, Eu²⁺, Eu³⁺, Fe³⁺, Fe³⁺, Gd³⁺, Mo³⁺, Ni²⁺, Ni⁺, Os³⁺, Os²⁺, Pt²⁺, Pt⁺, Re³⁺, Re²⁺, Rh²⁺, Rh⁺, Ru³⁺, Ru²⁺, Sm²⁺, Sm³⁺, Tc⁴⁺, Tc⁶⁺, Tc⁷⁺, W³⁺, Y³⁺, and Zn²⁺, along with the corresponding metal salt counterion (if present). In another such embodiment, the molecular building block metal ions are the same and are selected from the group consisting of Bi⁵⁺, Bi³⁺, Bi⁺; Cd²⁺, Cu²⁺, Cu⁺, Co³⁺, Co²⁺, Cr³⁺, Fe³⁺, Fe³⁺, Mo³⁺, Ni²⁺, Ni⁺, Pt²⁺, Pt⁺, Re³⁺, Re²⁺, Rh²⁺, Rh⁺, Ru³⁺, Ru²⁺, W³⁺, Y³⁺, and Zn²⁺, along with the corresponding metal salt counterion (if present). Suitable counterions include, for example, F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, and CO₃²⁻.

Other suitable coordinating metals include those described in U.S. Pat. No. 5,648,508 (hereby incorporated by reference herein in its entirety). In addition to the metal ions and metal salts described above, other metallic and metal-like compounds may be used, such as sulfates, phosphates, and other complex counterion metal salts of the main- and subgroup metals of the periodic table of the elements. Metal oxides, mixed metal oxides, with or without a defined stoichiometry may also be employed.

It will be understood that all metal ions in a given molecular building block can be in the same transition state or in more than one transition state. In some instances, for example, a counterion may be present to balance the charge. The counterions themselves may, or may not, be coordinated to the metal. Suitable counterions are described elsewhere herein.

In general, the heterocyclic macrocycles, in general, and the porphyrins, in particular, can coordinate with metal ions from Groups 1, 2, 3, 4, 5, 6, 7, 8, 9, 10, 11, 12, 13, 14, 15, and 16 (according to the IUPAC Group numbering format) or Groups IA, IIA, IIIB, IVB, VB, VIIB, VIIB, VIII, IB, IIB, IIIA, IVA, VA, and VIA (according to the Chemical Abstracts Service (CAS) numbering format) of the periodic table. This includes, for example, metal ions from the alkali metals, alkaline earth metals, transition metals, Lanthanides, Actinides, and other metals. In one embodiment, the metal atom coordinated by the metalated heterocyclic macrocycle is preferably a transition metal. For example, the metalated heterocyclic macrocycle may coordinate any of the 30 metals in the 3d, 4d and 5d transition metal series of the Periodic Table of the Elements, including the 3d series that includes Sc, Ti, V, Cr, Mn, Fe, Co, Ni, Cu, and Zn; the 4d series that includes Y, Zr, Nb, Mo, Tc, Ru, Rh, Pd, Ag and Cd; and the 5d series that includes Lu, Hf, Ta, W, Re, Os, Ir, Pt, Au and Hg. In some embodiments, the metal is from the 3d series. In some embodiments, the metal is selected from Co, Cd, Mn, Zn, Fe, and Ni.

Heterocyclic Macrocycles

The heterocyclic macrocycles employed as guest molecules in the supramolecular structures of the present invention may be any of a wide range of heteroatom-containing macrocycles, and metalated heterocyclic macrocycles, known in the art. In one embodiment, the metalated heterocyclic macrocycle is a meso-porphyrin, including metalated meso-porphyrins, a meso-porphyrazin, including metalated meso-porphyrazins, a meso-chlorin, including metalated meso-chlorins, a meso-corrin, including metalated meso-corrins, and meso-porphyrinogen, including metalated meso-porphyrinogens. The heterocyclic guest molecules may also have any of a wide range of symmetries including, for example, D_{3d}, D₃, C₃ᵥ, D₄ₕ, C₄ᵥ, C₂ᵥ, D₂ₕ, C₂ₕ, T_{d}, and D_{2d}. For example, in one embodiment the heterocyclic macrocycle guest molecule is a metalated porphyrin or porphyrinogen having D₄ₕ or D₂ₕ symmetry and the metal coordinated by the porphyrin is any of the metals identified elsewhere herein, such as cobalt, manganese, ruthenium or iron.

Porphyrins

The porphyrins employed as guest molecules in the supramolecular structures of the present invention may be any of a wide range of porphyrins, including metalated porphyrins, known in the art. In one embodiment, the porphyrin is a meso-porphyrin, including metalated meso-porphyrins.

In one embodiment, the porphyrin complex is a porphyrin corresponding to Formula P-1:

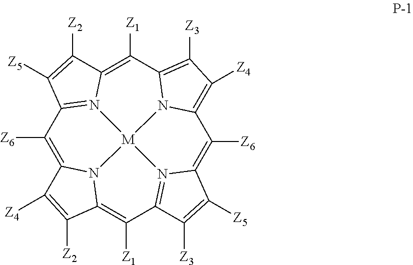

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the porphyrin is a chiral porphyrin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the porphyrin is a chiral porphyrin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the porphyrin has D₂-symmetry. In each of the foregoing embodiments, M may be a metal selected from Co, Cd, Mn, Ru, Zn, Fe, and Ni. For example, in each of the foregoing embodiments, M may be a metal selected from Co, Mn, Ru, and Fe.

In one exemplary embodiment, a preferred embodiment, Z₁ is

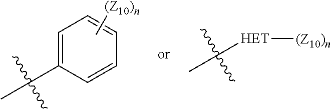

wherein

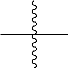

denotes the point of attachment of Z₁ to the porphyrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

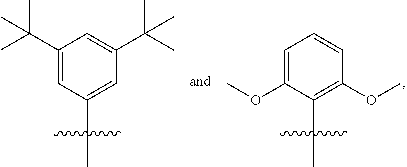

wherein

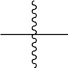

denotes the point of attachment of Z₁ to the porphyrin. In each of the foregoing embodiments, M may be a metal selected from Co, Cd, Mn, Zn, Fe, and Ni.

In one exemplary embodiment, a preferred embodiment, Z₆ is

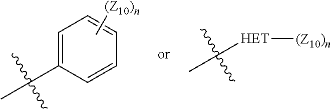

wherein

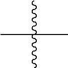

denotes the point of attachment of Z₆ to the porphyrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

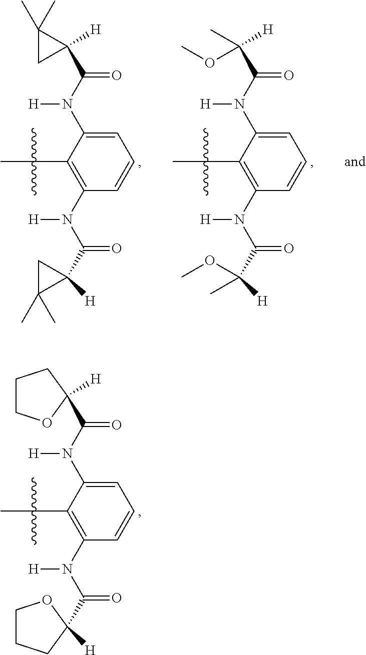

wherein

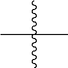

denotes the point of attachment of Z₆ to the porphyrin. In each of the foregoing embodiments, M may be a metal selected from Co, Cd, Mn, Zn, Fe, and Ni.

In one embodiment, the metalated porphyrin is a metalated tetraphenyl porphyrin. Exemplary metalated tetraphenyl porphyrins correspond to the following structure

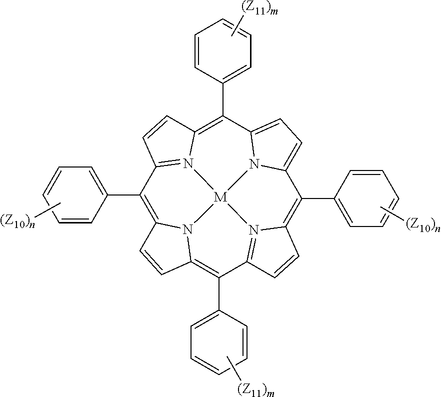

wherein n and m are independent 0-5, each Z₁₀ is hydrocarbyl, substituted hydrocarbyl, alkoxy or amino, and each Z₁₁ is hydrocarbyl, substituted hydrocarbyl, alkoxy or amino. In one such embodiment, M is cobalt, manganese, ruthenium or iron. By way of further example, exemplary metalated porphyrins include the following porphyrins, designated P11, P12, P13, P14, P15, P16, P17 and P18:

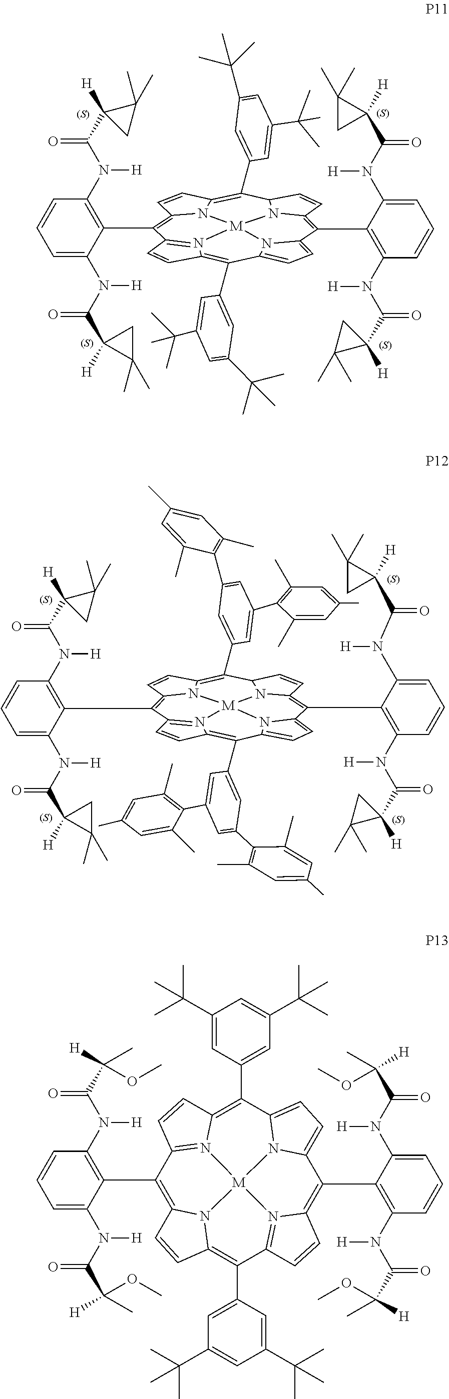

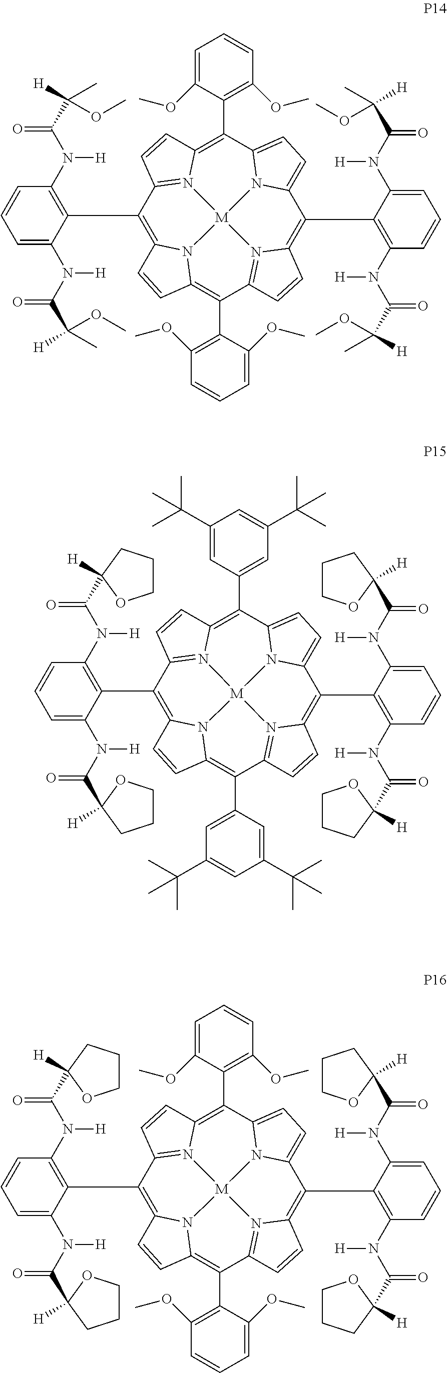

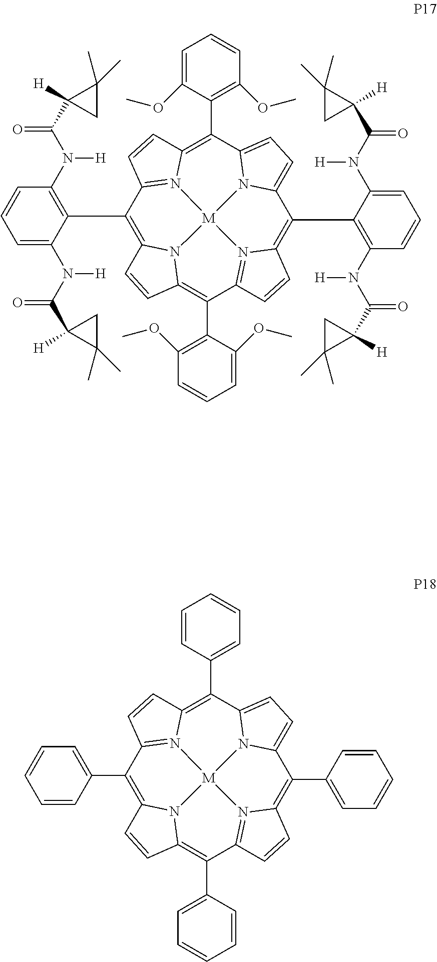

In one such embodiment, the porphyrin is a metalated porphyrin corresponding in structure to P11, P12, P13, P14, P15, P16, or P17 and M is Co(II). In another such embodiment, the porphyrin is a metalated porphyrin corresponding in structure to P11, P12, P13, P14, P15, P16, or P17 and M is Cd, Mn, Zn, Fe, or Ni.

Porphyrazins

The porphyrazins employed as structure directing agents in the process of the present invention may be any of a wide range of porphyrazins, including metalated porphyrazins, known in the art. In one embodiment, the porphyrin is a meso-porphyrazin, including metalated meso-porphyrazins.

In one embodiment, the porphyrin complex is a porphyrazin corresponding to Formula P-21:

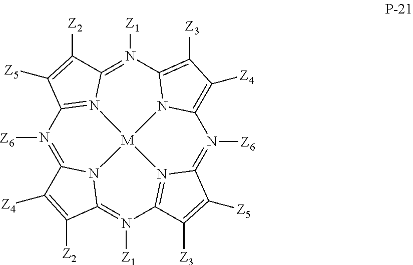

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the porphyrazin is a chiral porphyrazin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the porphyrazin is a chiral porphyrazin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the porphyrazin has D₂-symmetry. In each of the foregoing embodiments, M may be a metal selected from Co, Cd, Mn, Zn, Fe, and Ni.

In one exemplary embodiment, a preferred embodiment, Z₁ is

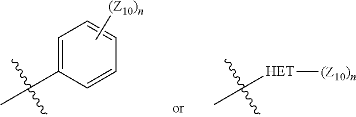

wherein

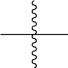

denotes the point of attachment of Z₁ to the porphyrazin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

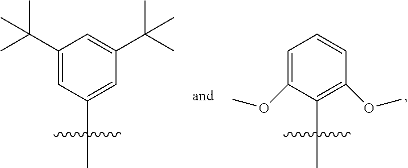

wherein

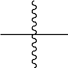

denotes the point of attachment of Z₁ to the porphyrazin. In each of the foregoing embodiments, M may be a metal selected from Co, Cd, Mn, Zn, Fe, and Ni.

In one exemplary embodiment, a preferred embodiment, Z₆ is

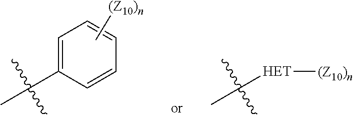

wherein

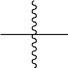

denotes the point of attachment of Z₆ to the porphyrazin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

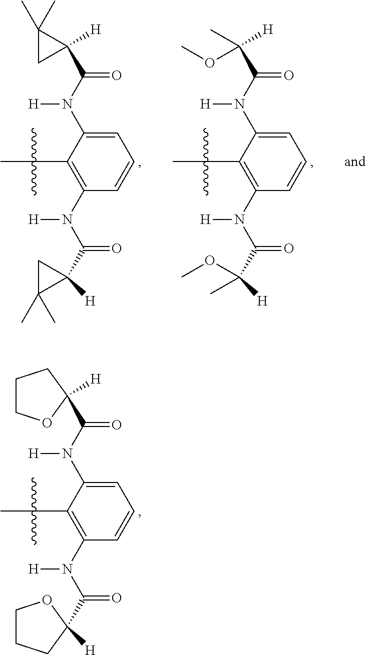

wherein

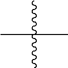

denotes the point of attachment of Z₆ to the porphyrazin. In each of the foregoing embodiments, M may be a metal selected from Co, Cd, Mn, Zn, Fe, and Ni.

Chlorins

The chlorins employed as structure directing agents in the process of the present invention may be any of a wide range of chlorins, including metalated chlorins, known in the art. In one embodiment, the chlorin is a meso-chlorin, including metalated meso-chlorins.

In one embodiment, the chlorin complex is a chlorin corresponding to Formula P-31:

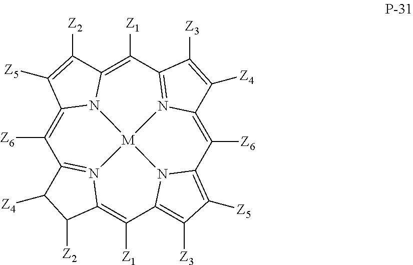

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the chlorin is a chiral chlorin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the chlorin is a chiral chlorin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the chlorin has D₂-symmetry. In each of the foregoing embodiments, M may be a metal selected from Co, Cd, Mn, Zn, Fe, and Ni.

In one exemplary embodiment, a preferred embodiment, Z₁ is

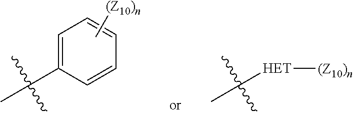

wherein

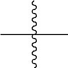

denotes the point of attachment of Z₁ to the chlorin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

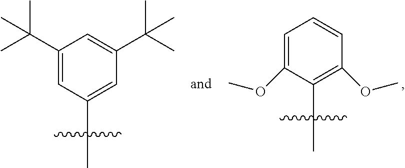

wherein

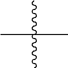

denotes the point of attachment of Z₁ to the chlorin. In each of the foregoing embodiments, M may be a metal selected from Co, Cd, Mn, Zn, Fe, and Ni.

In one exemplary embodiment, a preferred embodiment, Z₆ is

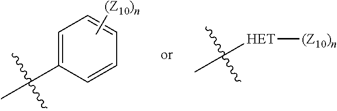

wherein

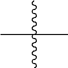

denotes the point of attachment of Z₆ to the chlorin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

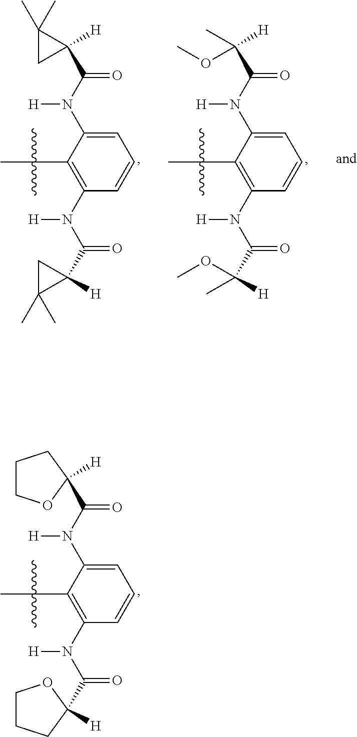 [SMILES: *c1c(NC(=O)[C@H]2CC2(C)C)cccc1NC(=O)[C@H]1CC1(C)C ; *c1c(NC(=O)[C@H](C)OC)cccc1NC(=O)[C@H](C)OC ; *c1c(NC(=O)[C@@H]2CCCO2)cccc1NC(=O)[C@@H]1CCCO1]

wherein

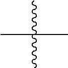

denotes the point of attachment of Z₆ to the chlorin. In each of the foregoing embodiments, M may be a metal selected from Co, Cd, Mn, Zn, Fe, and Ni.

Corrins

The corrins employed as structure directing agents in the process of the present invention may be any of a wide range of corrins, including metalated corrins, known in the art. In one embodiment, the corrin is a meso-corrin, including metalated meso-corrins.

In one embodiment, the corrin complex is a corrin corresponding to Formula P-41:

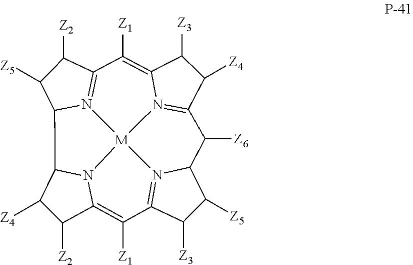

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the corrin is a chiral corrin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the corrin is a chiral corrin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the corrin has D₂-symmetry. In each of the foregoing embodiments, M may be a metal selected from Co, Cd, Mn, Zn, Fe, and Ni.

In one exemplary embodiment, a preferred embodiment, Z₁ is

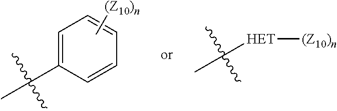

wherein

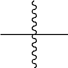

denotes the point of attachment of Z₁ to the corrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

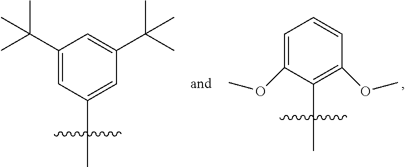

wherein

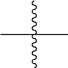

denotes the point of attachment of Z₁ to the corrin. In each of the foregoing embodiments, M may be a metal selected from Co, Cd, Mn, Zn, Fe, and Ni.

In one exemplary embodiment, a preferred embodiment, Z₆ is

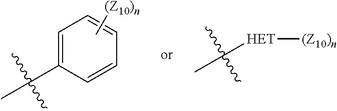

wherein

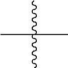

denotes the point of attachment of Z₆ to the corrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

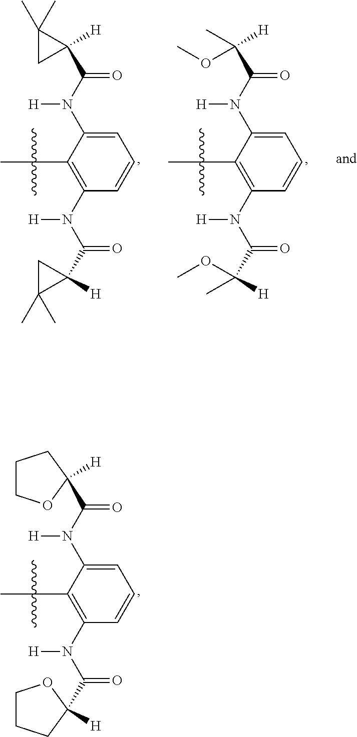 [SMILES: *c1c(NC(=O)[C@H]2CC2(C)C)cccc1NC(=O)[C@H]1CC1(C)C ; *c1c(NC(=O)[C@H](C)OC)cccc1NC(=O)[C@H](C)OC ; *c1c(NC(=O)[C@@H]2CCCO2)cccc1NC(=O)[C@@H]1CCCO1]

wherein

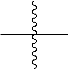

denotes the point of attachment of Z₆ to the corrin. In each of the foregoing embodiments, M may be a metal selected from Co, Cd, Mn, Zn, Fe, and Ni.

Porphyrinogens

The porphyrinogens employed as structure directing agents in the process of the present invention may be any of a wide range of porphyrinogens, including metalated porphyrinogens, known in the art. In one embodiment, the porphyrinogen is a meso-porphyrinogen, including metalated meso-porphyrinogens.

In one embodiment, the porphyrinogen complex is a porphyrinogen corresponding to Formula P-51:

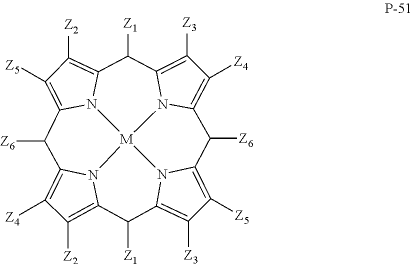

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the porphyrinogen is a chiral porphyrinogen. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the porphyrinogen is a chiral porphyrinogen. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the porphyrinogen has D₂-symmetry. In each of the foregoing embodiments, M may be a metal selected from Co, Cd, Mn, Zn, Fe, and Ni.

In one exemplary embodiment, a preferred embodiment, Z₁ is

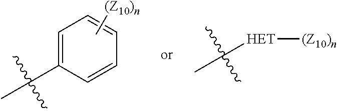

wherein

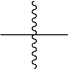

denotes the point of attachment of Z₁ to the porphyrinogen, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

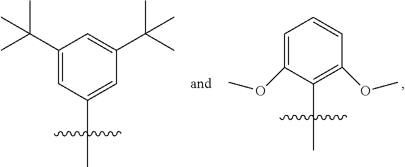

wherein

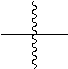

denotes the point of attachment of Z₁ to the porphyrinogen. In each of the foregoing embodiments, M may be a metal selected from Co, Cd, Mn, Zn, Fe, and Ni.

In one exemplary embodiment, a preferred embodiment, Z₆ is

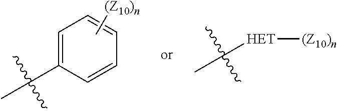

wherein

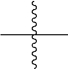

denotes the point of attachment of Z₆ to the porphyrinogen, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

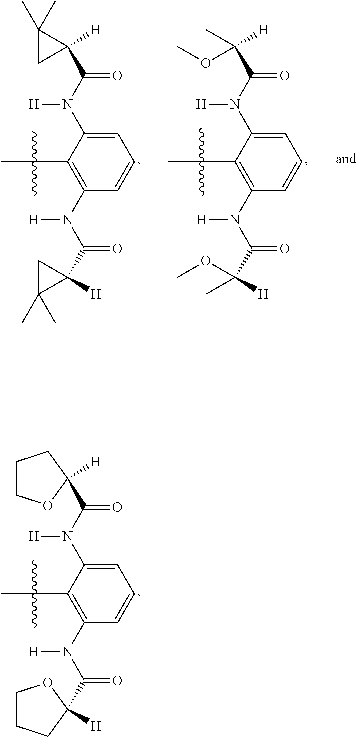 [SMILES: *c1c(NC(=O)[C@H]2CC2(C)C)cccc1NC(=O)[C@H]1CC1(C)C ; *c1c(NC(=O)[C@H](C)OC)cccc1NC(=O)[C@H](C)OC ; *c1c(NC(=O)[C@@H]2CCCO2)cccc1NC(=O)[C@@H]1CCCO1]

wherein

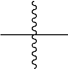

denotes the point of attachment of Z₆ to the porphyrinogen. In each of the foregoing embodiments, M may be a metal selected from Co, Cd, Mn, Zn, Fe, and Ni.

In one embodiment, the metalated porphyrin is a metalated tetraphenyl porphyrin. Exemplary metalated tetraphenyl porphyrins correspond to the following structure

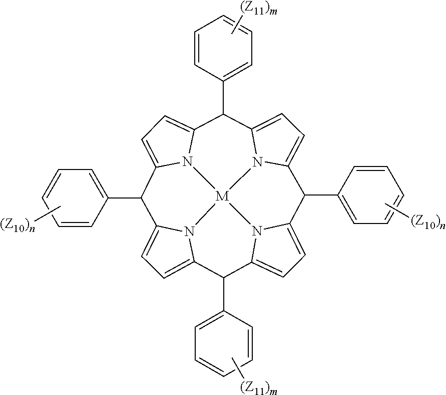

wherein n and m are independent 0-5, each Z₁₀ is hydrocarbyl, substituted hydrocarbyl, alkoxy or amino, and each Z₁₁ is hydrocarbyl, substituted hydrocarbyl, alkoxy or amino. In one such embodiment, M is cobalt, manganese, ruthenium or iron.

Supramolecular Metal Organic Material

The organic ligands, metals and heterocyclic macrocycles may be combined to form any of a range of molecular building blocks. In one embodiment, the molecular building blocks may be selected from those identified in Table 2.

TABLE 2
A Cambridge Structural Database analysis of the occurrence
(# of hits) of four examples of molecular building
blocks that can serve as nodes.

| | # of | |
|---|---|---|
| MBB | hits | Number of structures for specific metals |
| Square | 2075 | Cu(1027), Rh(414), Ru(212), Mo(125), Zn(68), |
| paddlewheel | | Fe(52), Cr(48), Co(26), Ni(25), W(21), Mn(10), |
| [M(COO)₄] | | Re(10), Cd(7), V(6), Bi(6), Tc(6), Os(5), Ti(4), |
| | | Pt(3), Hg(2), In(1), Mg(1), Al(1), Sc(1) |
| Octahedral | 5813 | Ru(1375), Co(768), Ni(754), Fe(674), Cu(589), |
| [M(py)₄(nM)₂] | | Mn(490), Zn(398), Cd(254), Os(91), Ir(77), |
| nM = non- | | Cr(71), Rh(56), V(47), Re(28), Pb(24), Hg(22), |
| metallic | | Ga(18), Mo(17), Tc(17), Yb(8), Ti(7), Al(7), |
| elements | | Na(6), Ag(5), Mg(4), W(4), Nb(3), Pt(3), Eu(2), |
| | | In(2), Pd(1), Sn(1), Tl(1), Ca(1), K(1), |
| | | Zr(1), Sm(1) |
| Trigonal prism | 497 | Fe(170), Cr(80), Mn(47), Ru(41), Mo(22), |
| [M₃O(COO)₆] | | W(23), V(17), Ir(4), Nb(4), Co(3), Rh(3), |
| | | Be(3), Ni(2), In(2), Al(2), Sc(1), Zn(1) |
| Octahedron | 50 | Zn(42), Co(3), Be (3), Cu(2) |
| [M₄O(COO)₆] | | |

Having described the invention in detail, it will be apparent that modifications and variations are possible without departing the scope of the invention defined in the appended claims. Furthermore, it should be appreciated that all examples in the present disclosure are provided as non-limiting examples.

The following non-limiting examples are provided to further illustrate the present invention. It should be appreciated by those of skill in the art that the techniques disclosed in the examples that follow represent approaches the inventors have found function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### MOMzyme Preparation

Fe(3+)4SP-HKUST-1(Cu), Mn(3+)₄SP-HKUST-1(Cu) and Cu(2+)T4MPyP were prepared by mixing 15 ml of a 1:1 (V:V) ethanol:dimethyl formamide solution containing 0.5 g of 1,3,5 benzene tricarboxylate and 30 mg of the porphyrin of interest with 7.5 ml of water containing 1.04 g of Cu(2+)(NO₃)₂.3H₂O in a 25 ml scintillation vial. The vial was then sealed with a plastic screw cap and heated in an oil bath at 60° C. for 7 hours. The vial was then allowed to cool to room temperature at which time the solution was carefully decanted and the resulting solid crystalline material was collected by centrifugation. The crystals were then washed extensively with ethanol.

Fe(3+)4SP-HKUST-1(Zn) and Mn(3+)₄SP-HKUST-1(Zn) were prepared by carefully layering 10 ml of a solution containing 0.220 g of 1,3,5 benzene tricarboxylate, 0.220 g of Zn(2+)(NO₃)₂.6H₂O and 30 mg of the porphyrin of interest over 10 ml of nitrobenzene containing 230 μl of pyridine in a 25 ml scintillation vial. After ˜4 days dark crystals appeared on the side of the vial. The solution was then decanted and the crystals collected by centrifugation. The crystals were washed extensively with a 1:1 (V:V) solution of methanol:nitrobenzene.

Single Crystal Specular Reflectance Spectroscopy

Single crystal UV/vis spectra were obtained using a polarized specular reflectance spectrophotometer. This is a single beam, wide range, fast acquisition spectrophotometer. The optics retains focus over a wide range of wavelengths (mid IR-far UV) through the use of reflecting optics in all instances except the polarizer. Light sources are a xenon arc lamp and a tungsten-halogen lamp, the polarizer is a MgF₂ Rochon prism, optics are spherical and planar reflectors with an Ealing Optics reflecting objective. Image beam size is 30 μm (0.030 mm), sample, reference mirror, and beam-directing mirror motions are normally computer controlled but are temporarily manually controlled, UV and visible dispersion is through an Acton Research SpectraPro® 275 spectrograph, and detection is with a Princeton Instruments 1152×296 EEV (English Electric Valve) CCD (Charge-Coupled Device), maintained at 110K. All instrument control and data collection is through a Macintosh computer. Spectra are recorded from selected highly-reflective natural faces of crystals. The average of 50 spectra is reported in each case; the exposure time for each ranges from 0.01 to 20 sec., depending on the spectral region. The data are corrected for percent reflectivity relative to a NIST standard mirror.

MOMzyme Peroxidase Assays

The MOMzyme peroxidase activity was assayed using 2,2′ azinodi(3-ethylbenzthiazoline)-6-sulfonate (ABTS) as a redox indicator by monitoring the rate of increase in absorbance at 660 nm (absorption maximum for ABTS^{+•}) subsequent to the addition of peroxide a solution of metalloporphyrin-MOMzyme, heme protein or heme model complex and ABTS. The assay solution contained 250 μM ABTS in 2 ml of ethanol. The reaction was initiated by the addition of 2 μl of a 15% H₂O₂ solution in ethanol:water (1:1, V:V) and continuously stirred throughout the assay. Rate constants were obtained by fitting the change in absorbance at 660 nm (ε=12 mM⁻¹ cm⁻¹) versus time data to a single exponential rise function. Assays involving hhMb were performed in 50 mM Phosphate buffer. For recycling experiments the samples were washed three times in ethanol and air dired overnight prior to each catalytic run.

MOMzyme Physical Characterization

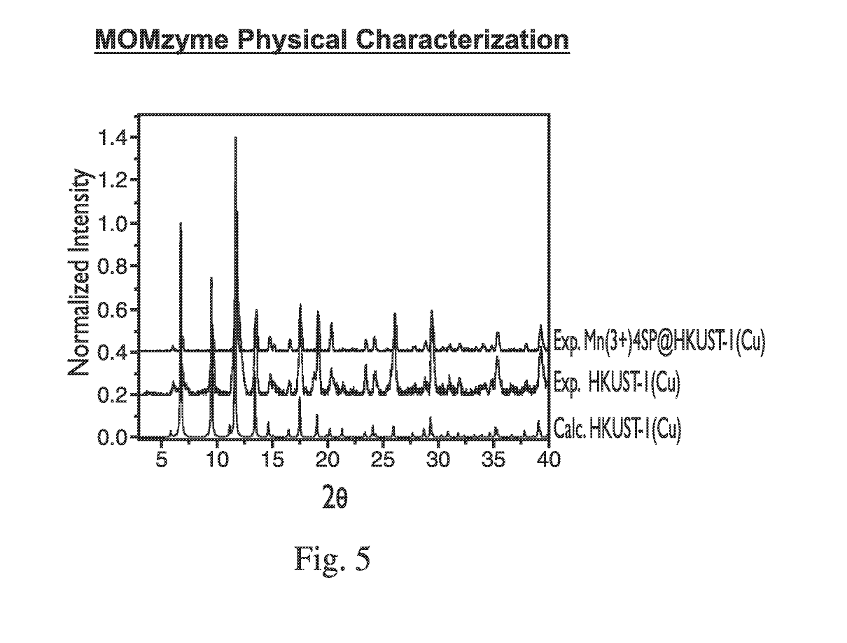

FIG. 5 depicts powder X-ray diffractions, calculated HKUST-1(Cu) experimental HKUST-1(Cu), and experimental Mn(3+)4SP@HKUST-1(Cu). Powder patterns were obtained using a Bruker D8 ADVANCE, θ/2θ diffractometer using CuKα radiation (λ=1.54056 Å). 2θ scans between 3° and 40° with a step size of 0.02° were performed on a rotating platform for duration of fifteen minutes and twenty-six seconds.

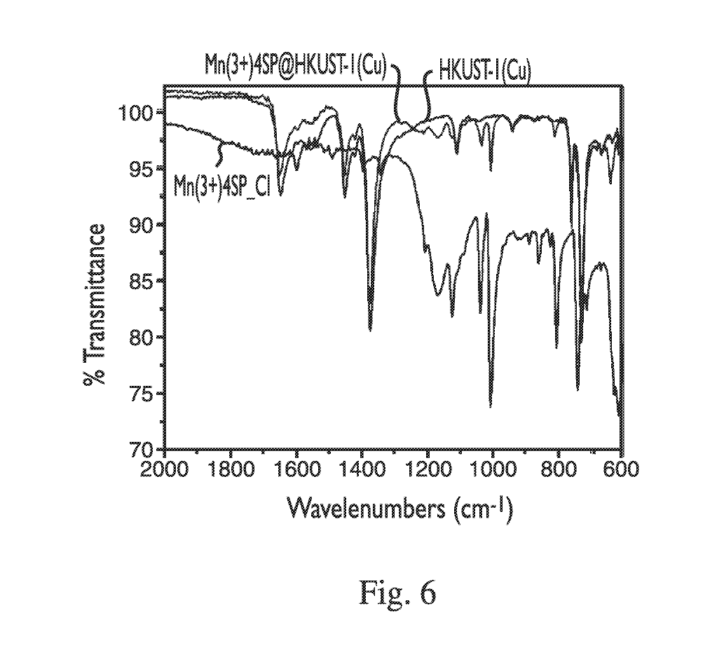

FIG. 6 depicts spectra for HKUST-1(Cu), Mn(3+)4SP@HKUST-1(Cu) (red), and Mn(3+)4SP_Cl. Spectra were recorded on a Nicolet Avatar 320 FT-IR spectrometer from 600 cm⁻¹ to 4000 cm⁻¹ by combining 32 scan with 4 cm⁻¹ resolution. The region shown from 2000-600 cm⁻¹ details the fingerprint region in which peaks at 1032 cm⁻¹ and 1004 cm⁻¹ are observed in both Mn(3+)4SP_Cl and Mn(3+)4SP@HKUST-1(Cu) but not observed in HKUST-1(Cu).

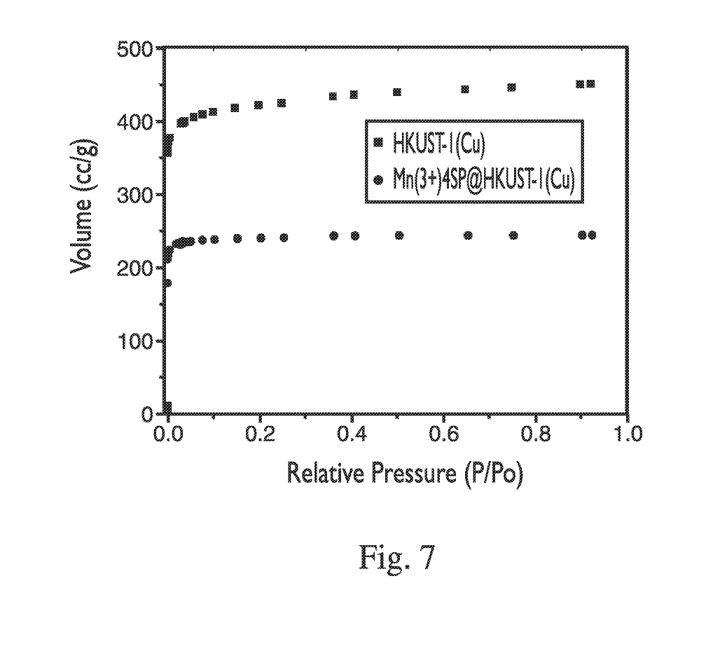

FIG. 7 depicts nitrogen isotherms of HKUST-1(Cu) and Mn(3+)4SP@HKUST-1(Cu). Isotherms were recorded using a NOVA 2000 series Quantachrome instrument at 77 K.

MOMzyme X-ray Diffraction

Crystal structures of MOMzymes were determined using single-crystal X-ray diffraction. Structures were solved using Patterson methods, expanded using Fourier methods and refined using nonlinear least-squares techniques on F². The X-ray diffraction data were collected using Bruker-AXS SMART-APEXII CCD diffractometer (CuKα, λ=1.54178 Å) for CuT4MPyP@HKUST-1(Cu), Mn4SP@HKUST-1(Cu) and Fe4SP@HKUST-1(Zn) MOMzymes. Synchrotron radiation (Advanced Photo Source at Argonne National Lab, λ=0.40663 Å) was used in order to determine the structures of Fe4SP@HKUST-1(Cu) Mn4SP@HKUST-1(Zn) compounds. In all cases indexing was performed using APEX2 [1]. Data integration and reduction were performed using SaintPlus 6.01 [2]. Absorption correction was performed by multi-scan method implemented in SADABS [3]. Space groups were determined using XPREP implemented in APEX2 [1]. Structures were solved using SHELXS-97, expanded using Fourier methods and refined on F² using nonlinear least-squares techniques with SHELXL-97 contained in APEX2 [S1] and WinGX v1.70.01 [ S4-S7] programs packages. The Fourier maps were calculated using Fourier_Map routine in Wingx [S4] and plotted using MCE, Version 2005 2.2.0 [S8]. All non-hydrogen, framework atoms were refined anisotropically. For all of the structures, metal atoms of porphyrin's core was found from Fourier difference map and refined anisotropically with, depending on the structure, ⅓ to ⅔ site occupancies. Metal atom of the porphyrin core was found from Fourier difference map and refined anisotropically with ⅓ to ⅔ (for different structures) site occupancy—in each case the occupancy was determined through the refinement. The remaining non-hydrogen atoms of the porphyrin were found from a difference Fourier map and refined isotropically using geometry restraints. Although the porphyrin atoms could easily be seen on Fo-Fc or Fo Fourier maps, the restrained refinement was necessary due to the porphyrin disorder and the fact that porphyrin loading is lower than 100%. The observed disorder is caused by the presence of porphyrin (4 fold symmetry) in the cages of higher symmetry (Oₕ). Although the porphyrin is disordered over three positions, the porphyrin planes can be seen clearly since the D₄ₕ symmetry of the porphyrin's core is a subgroup of symmetry of the cage. In case of benzenesulfonic and 4-N-methylpyridyl groups of porphyrins, additional disorder causes the electron density to be more diffuse. Presented model for these two groups can be considered as an average of all disordered parts. Overall disorder of these groups is additionally complicated through the presence of solvent molecules. Regardless the disorder, presence of porphyrin is unambiguous due to the fact that it is actually locked in the octahemioctahedral cages with benzenesulfonic groups oriented through the square windows of these cages. That allowed for easy location and anisotropic refinement of heavy atom as well as for isotropic refinement of the rest of the atoms. The estimated (refined) loading of porphyrin in frameworks is as follows: CuT4MPyP@HKUST-1(Cu)—66%, Fe4SP@HKUST-1(Cu)—50%, Mn4SP@HKUST-1(Cu)—50%, Fe4SP@HKUST-1(Zn)—33%, Mn4SP@HKUST-1(Zn)—50%.

The charge is balanced by NO₃⁻ anions in case of CuT4MPyP-HKUST(Cu) and it is assumed that porphyrin is protonated in the structures of 4SP-MOMzymes. All the hydrogen atoms were located geometrically and included in the refinement process using riding model with isotropic thermal parameters: Uiso(H)=1.2Ueq(CH) and Uiso(H)=1.5Ueq(CH₃). Crystal data and refinement conditions are presented in Tables 3 and 4.
[S1] Bruker (2010). (APEX2). Bruker AXS Inc., Madison, Wis., USA.
[S2] Bruker (2009). SAINT. Data Reduction Software. Bruker AXS Inc., Madison, Wis., USA.
[S3] Sheldrick, G. M. (2008). SADABS. Program for Empirical Absorption
Correction. University of Gottingen, Germany.
[S4] Farrugia L. J. Appl. Cryst. (1999). 32, 837±838
[S5] Sheldrick, G. M. (1997) SHELXL-97. Program for the Refinement of Crystal
[S6] Sheldrick, G. M. (1990) Acta Cryst. A46, 467-473
[S7] Sheldrick, G. M. (2008) Acta Cryst. A64, 112-122.
[S8] Rohlicek J., Husak M. (2007) J. Appl. Cryst. 40, 600-601.

TABLE 3
Crystal data and structure refinement
for compound Fe4SP@HKUST(Cu)

| | |
|---|---|
| Empirical formula | C376 H332 Cu48 Fe2 N8 O310 S8 = |
| (Unit cell content) | 32(C9H3O6)),48Cu,48(H2O), |
| | 2(C44H24N4Fe1S4O12H3), |
| | 46(H2O |
| Formula weight | 13340.60 |
| Temperature | 100(2) K. |
| Wavelength | 0.40663 Å |
| Crystal system, | Cubic, Fm-3m |
| space group | a = 26.387(5) Å alpha = 90 deg. |
| Unit cell dimensions | b = 26.387(5) Å beta = 90 deg. |
| | c = 26.387(5) Å gamma = 90 deg. |
| | 18373(8) Å\hat{ }3 |
| Volume | 1, 1.206 Mg/m\hat{ }3 |
| Z, Calculated | 0.295 mm\hat{ }−1 |
| density | 6696 |
| Absortion coefficient | 0.02 × 0.02 × 0.02 mm |
| F(000) | 1.25 to 14.36 deg. |
| Crystal size | −26 <= h <= 26, −31 <= k <= 16, −32 <= l <= 22 |
| Theta range for data | 15981/930 [R(int) = 0.0830] |
| collection | 99.0% |
| Limiting indices | Semi-empirical from equivalents |
| Reflections collected/ | 0.9941 and 0.9941 |
| unique | Full-matrix least-squares on F\hat{ }2 |
| Completeness to | 930/21/63 |
| theta = 64.53 | 1.065 |
| Absorption | R1 = 0.0722, wR2 = 0.2206 |
| correction | R1 = 0.0912, wR2 = 0.2426 |
| Max. and min. | 0.829 and −0.969 e. Å\hat{ }−3 |
| transmission | |
| Refinement method | |
| Data/restraints/ | |
| parameters | |
| Goodness-of-fit on | |
| F\hat{ }2 | |
| Final R indices | |
| [I > 2sigma(I)] | |
| R indices (all data) | |
| Largest diff. peak | |
| and hole | |

TABLE 4
Crystal data and structure refinement
for compound Fe4SP@HKUST(Zn)

| | |
|---|---|
| Empirical formula | C346.67 H298.67 Fe1.33 N5.33 |
| | O293.33 S5.33 Zn48 |
| (Unit cell content) | 32(C9H3O6)),48Zn,48(H2O), |
| | 1.333(C44H24N4Fe1S4O1 |
| | 2H3), |
| Formula weight | 37.3333H2O |
| Temperature | 12617.4 |
| Wavelength | 100(2) K. |
| Crystal system, space group | 1.54178 Å |
| Unit cell dimensions | Cubic, Fm-3m |
| | a = 26.5108(4) Å alpha = 90 deg. |
| | b = 26.5108(4) Å beta = 90 deg. |
| Volume | c = 26.5108(4) Å gamma = 90 deg. |
| Z, Calculated density | 18632.4(5) Å\hat{ }3 |
| Absortion coefficient | 1, 1.124 Mg/m\hat{ }3 |
| F(000) | 2.615 mm\hat{ }−1 |
| Crystal size | 6323 |
| Theta range for data | 0.10 × 0.10 × 0.10 mm |
| collection | 4.72 to 66.59 deg. |
| Limiting indices | −19 <= h <= 31, −29 <= k <= 30, |
| | −19 <= l <= 26 |
| Reflections collected/ | 7909/878 [R(int) = 0.0243] |
| unique | 98.5% |
| Completeness to theta = | Semi-empirical from equivalents |
| 64.53 | 0.7800 and 0.7800 |
| Absorption correction | Full-matrix least-squares on F\hat{ }2 |
| Max. and min. transmission | 878/16/63 |
| Refinement method | 1.026 |
| Data/restraints/ | R1 = 0.0713, wR2 = 0.2570 |
| parameters | R1 = 0.0757, wR2 = 0.2639 |
| Goodness-of-fit on F\hat{ }2 | 0.806 and −0.670 e. Å\hat{ }−3 |
| Final R indices [I > 2sigma(I)] | |
| R indices (all data) | |
| Largest diff. peak and hole | |

### REFERENCES

1. J. T. Groves, Models and Mechanisms of Cytochrome P-450 Action. In Cytochrome P450: Structure, Mechanism and Biochemistry; Ortiz de Montellano, P. R. Ed.; Kluwer Academic/Plenum Publishers: New York, 2005, pp. 1-44.
2. Reedy, C. J., Gibney, D. R. Heme protein assemblies Chem. Rev., 104, 617 (2004).
3. Morgan, B., Dolphin, D. Synthesis and structure of biomimetic porphyrins Struct. & Bonding, 64, 115-199 (1987).
4. Collman, J. P., Boulatov, R., Sunderland, C. J., Fu, L. Functional analogues of cytochrome c oxidase, myoglobin, and hemoglobin Chem. Rev., 104, 561-588 (2004).
5. Dawson, J. H. Probing structure-function relations in heme-containing oxygenases and peroxidases Science, 240, 433-439 (1988).
6. Li, H., Poulos, T. L. Structural variation in heme enzymes: a comparative analysis of peroxidase and P450 crystal structures Structure, 2, 461-464 (1994). 7. Perry, J. J., Perman, J. A., Zaworotko, M. J., Design and synthesis of metal-organic frameworks using metal-organic polyhedra as supermolecular building blocks Chem. Soc. Rev., 38, 1400-1417 (2009).
8. Coordination Polymers: Design, Analysis and Application. Batten, S. R.; Neville, S. M.; Turner, D. R. Royal Society of Chemistry, Cambridge, UK, 2009.
9. Kitagawa, S., Kitaura, R. and Noro, S.-i., Functional Porous Coordination Polymers. Angew. Chem. Int. Ed., 43, 2334-2375 (2004).

10. Eddaoudi, M. et al. Modular chemistry: secondary building units as a basis for the design of highly porous and robust metal-organic carboxylate frameworks Accts. Chem. Res., 34, 319-330 (2001).
11. Moulton B., Zaworotko, M. J. From molecules to crystal engineering: supramolecular isomerism and polymorphism in network solids Chem. Rev., 101, 1629-1658 (2001).
12. J. R. Lindsay-Smith, Metalloporphyrins in Catalytic Oxidations
(Marcel Dekker Inc., New York, 1994), p. 325.
13. Battioni, P., et al. Metalloporphyrinosilicas: a new class of hybrid organic-inorganic materials acting as selective biomimetic oxidation catalysts Chem. Comm. 2037-2038 (1996).
14. Schick, G. A., et al. Spectroscopic characterization of porphyrin monolayer assemblies J. Am. Chem. Soc., 111, 1344-1350 (1989).
15. Drain, C. M., Varotto, A., Radivojevic, I. Self-organized porphyrinic materials Chem. Rev., 109, 1630-1658 (2009).
16. Liu, C-J., Li, S-G., Pang, W-Q, Che, C-M. Ruthenium porphyrin encapsulated in modified mesoporous molecular sieve MCM-41 for alkane oxidation Chem. Commun., 65-66 (1997).
17. Holland, B. T., Walkup, C., Stein, A. Encapsulation, stabilization, and catalytic properties of flexible metal porphyrin complexes in MCM-41 with minimal electronic perturbation by the environment, J. Phys. Chem. B., 102, 4301-4309 (1998).
18. J. H. M. Heijnen et al., ACS Symposium Series, Vol. 819, 191 (2002).
19. Nestler, O., Severin, K. A ruthenium porphyrin catalyst immobilized in a highly cross-linked polymer Org. Lett., 3, 3907-3909 (2001).
20. Yu, X-Q, Huang, J-S., Yu, W-Y., Che, C-M. Polymer-supported ruthenium porphyrins: versatile and robust epoxidation catalysts with unusual selectivity J. Am. Chem. Soc., 122, 5337-5342 (2000).
21. Alkordi, M. H., Liu, Y., Larsen, R. W., Eubank, J. F., Eddaoudi, M., Zeolite-like metal-organic frameworks as platforms for applications: on metalloporphyrin-based catalysts J. Am. Chem. Soc., 130 12639-12641 (2008).
22. Chui, S. S—Y., et al. A chemically functionalizable nanoporous material [Cu₃(TMA)₂(H₂O)₃]ₙ Science, 283, 1148-1150 (1999).
23. Lu, J. et al. Self assembly of nanometer-scale sacondary building units into an undulating two-dimensional network with two types of hydrophobic cavity Angew. Chem., Int. Ed, 40, 2111-2113 (2001).
24. Sun, C. Y., et al. Highly stable crystalline catalysts based on a microporous metal-organic framework and polyoxometalates J. Am. Chem. Soc., 131, 1883-1888 (2009).
25. Gandini, S. C. M., Yushmanov, V. E., Tabak, M. Interaction of Fe(III)- and Zn(II)-tetra(4-sulfonatophenyl) porphyrins with ionic and nonionic surfactants: aggregation and binding J. Inorg. Biochem., 85, 263-277 (2001).
26. Bruice, T. C., Zipples, M. F., Lee, W. A. The pH dependence of the mechanism of reaction of hydrogen peroxide with a nonaggregating, non-mu-oxo dimer-forming iron (III) porphyrin in water Proc. Natl. Acad. Sci. USA, 83, 4646-4649 (1986).
27. McMurry, T. and Groves, J. T. Cytochrome P450, Structure, Mechanism and Biochemistry, ed. P. Ortiz de Montellano, Plenum, London, 1986.

What is claimed is:

1. A supramolecular assembly comprising a metal-organic molecular framework and a heterocyclic macrocycle guest molecule, the metal-organic molecular framework comprising cubicuboctahedral cavities, octahemioctahedral cavities and trigonal cavities in a 1:1:2 ratio, respectively, the heterocyclic macrocycle guest molecule being hosted by the octahemioctahedral cavity.

2. The supramolecular assembly of claim 1 wherein the heterocyclic macrocycle guest molecule is a porphyrin, a porphyrazin, a chlorin, a corrin, or a porphyrinogen.

3. The supramolecular assembly of claim 1 wherein the heterocyclic macrocycle guest molecule is a metalated porphyrin, a metalated porphyrazin, a metalated chlorin, a metalated corrin, or a metalated porphyrinogen.

4. The supramolecular assembly of claim 1 wherein the heterocyclic macrocycle guest molecule is a metalated porphyrin, a metalated porphyrazin, a metalated chlorin, a metalated corrin, or a metalated porphyrinogen and the metal coordinated by the metalated porphyrin, metalated porphyrazin, metalated chlorin, metalated corrin, or metalated porphyrinogen is a transition metal.

5. The supramolecular assembly of claim 1 wherein the heterocyclic macrocycle guest molecule comprises cobalt, manganese, ruthenium or iron as a coordinated metal.

6. The supramolecular assembly of claim 1 wherein the heterocyclic macrocycle guest molecule is a porphyrin and the porphyrin comprises cobalt, manganese, ruthenium or iron as a coordinated metal.

7. The supramolecular assembly of claim 1 wherein the heterocyclic macrocycle guest molecule is an iron porphyrin.

8. The supramolecular assembly of claim 1 wherein the heterocyclic macrocycle guest molecule is a metalated meso-porphyrin, a metalated meso-porphyrazin, a metalated meso-chlorin, a metalated meso-corrin, or a metalated meso-porphyrinogen and the metal coordinated by the metalated meso-porphyrin, metalated meso-porphyrazin, metalated meso-chlorin, metalated meso-corrin, or metalated meso-porphyrinogen is a transition metal.

9. The supramolecular assembly of claim 1 wherein the metal-organic molecular framework is an assembly comprising a metal ion and organic ligands, the organic ligands being linear, branched or cyclic and having the capacity to coordinate at least two metals.

10. The supramolecular assembly of claim 9 wherein the organic ligands comprise metal coordinating groups selected from among carboxylates, nitrogen-containing heterocycles, phenoxy groups, and combinations thereof.

11. The supramolecular assembly of claim 9 wherein the organic ligands comprise metal coordinating groups selected from among —CO₂H, —CS₂H, —NO₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(SH)₂, —C(SH)₃, —CH(NH₂)₂, —C(NH₂)₂, —CH(OH)₂, —C(OH)₃, —CH(CN)₂ and —C(CN)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, and combinations thereof wherein each R is independently an alkyl or alkenyl group having from 1 to 5 carbon atoms, or an aryl group consisting of 1 to 2 phenyl rings.

12. The supramolecular assembly of claim 9 wherein the organic ligands comprise metal coordinating groups selected from among nitrogen donors.

13. The supramolecular assembly of claim 9 wherein the organic ligands comprise metal coordinating groups corresponding to Formula (1):
R₁-L₁-AL₃-R₃)ₙ (1)
wherein
A is a bond or a monocyclic ring or polycyclic ring system;
L₁ and each L₃ is a linker moiety;
n is at least 1 and
R₁ and each R₃ is independently a functional group capable of coordinately bonding to at least one metal ion.

14. The supramolecular assembly of claim 13 wherein n is 2.

15. The supramolecular assembly of claim 13 wherein R₁ and each R₃ is selected from among carboxylates, nitrogen-containing heterocycles, phenoxy groups, and combinations thereof.

16. The supramolecular assembly of claim 13 wherein A is a six-membered carbocyclic or heterocyclic ring.

17. The supramolecular assembly of claim 13 wherein A is a ring selected from the following six-membered rings: 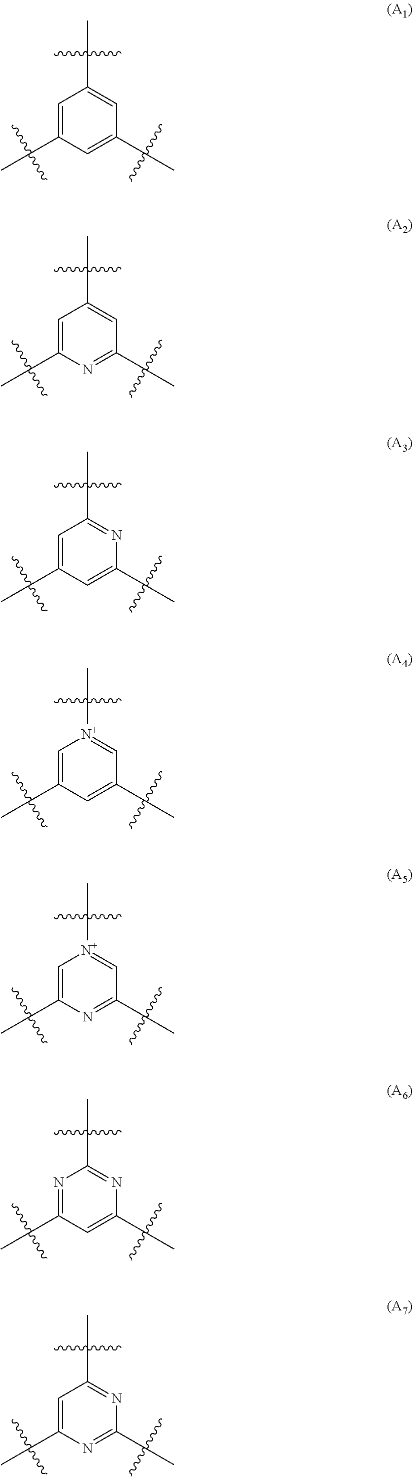 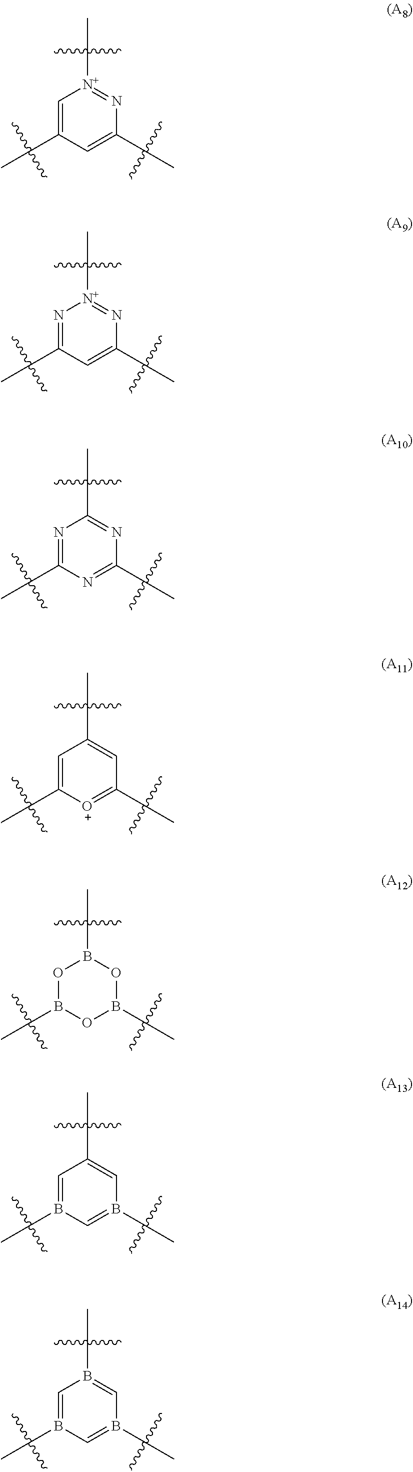 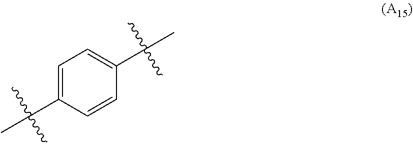 [SMILES: *c1ccc(*)cc1]
wherein the wavy lines represent the attachment point of the A ring to the remainder of the ligand compound corresponding to Formula (1).

18. The supramolecular assembly of claim 13 wherein A is a ring selected from the following: 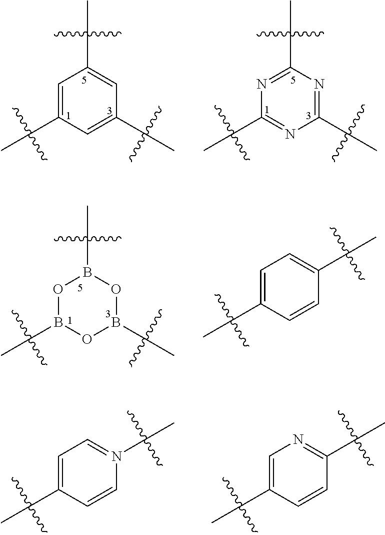
wherein the wavy lines represent the attachment point of the A ring to the remainder of the ligand compound corresponding to Formula (1).

19. The supramolecular assembly of claim 13 wherein A is a ring selected from the following: 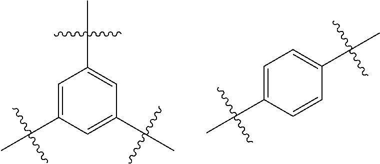 [SMILES: *c1cc(*)cc(*)c1 ; *c1ccc(*)cc1]
wherein the wavy lines represent the attachment point of the benzene ring to the remainder of the ligand compound corresponding to Formula (1).

20. The supramolecular assembly of claim 13 wherein A is a ring selected from the following: 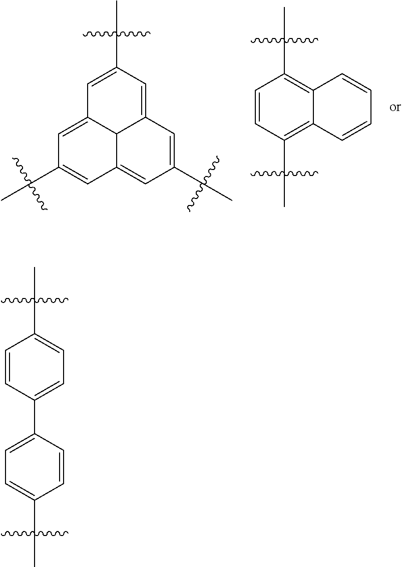 [SMILES: *C1=CC2=CC(*)=CC3=CC(*)=CC(=C1)C23 ; *c1ccc(*)c2ccccc12 ; *c1ccc(-c2ccc(*)cc2)cc1]
wherein the wavy lines represent the attachment point of the A ring to the remainder of the organic ligand.

21. The supramolecular assembly of claim 13 wherein the metal-organic molecular framework is an assembly comprising a metal ion selected from metal ions of Group 1, 2, 3, 4, 5, 6, 7, 8, 9, 10, 11, 12, 13, 14, 15, or 16 of the Periodic Table (IUPAC Group numbering format).

22. The supramolecular assembly of claim 13 wherein the metal-organic molecular framework is an assembly comprising a metal ion selected from the group consisting of alkali metal ions, alkaline earth metal ions, transition metal ions, Lanthanide ions, Actinide ions, and combinations thereof.

23. The supramolecular assembly of claim 13 wherein the metal-organic molecular framework is an assembly comprising a transition metal ion.

24. The supramolecular assembly of claim 13 wherein the metal-organic molecular framework is an assembly comprising a metal ion selected from the group consisting of Ag⁺, Al³⁺, Au⁺, Cu²⁺, Cu⁺, Fe²⁺, Fe³⁺, Hg²⁺, Li⁺, Mn³⁺, Mn²⁺, Nd³⁺, Ni²⁺, Ni⁺, Pd²⁺, Pd⁺, Pt²⁺, Pt⁺, TI³⁺, Yb²⁺ and Yb³⁺, along with the corresponding metal salt counterion (if present).

25. The supramolecular assembly of claim 13 wherein the metal-organic molecular framework is an assembly comprising a metal ion selected from the group consisting of copper, chromium, iron or zinc ions along with the corresponding metal salt counterion (if present).

26. The supramolecular assembly of claim 25 wherein the metal-organic molecular framework is an assembly comprising a metal ion and a corresponding metal salt counterion, the metal salt counterion being selected from the group consisting of F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, and CO₃²⁻.
